(19) United States
(12) Patent Application Publication
(10) Pub. No.: US 2026/0161780 A1
(43) Pub. Date: Jun. 11, 2026

(54) COMPOUND AI SYSTEM FOR AUTOMATED SECURITY ALERT INVESTIGATION UTILIZING MULTI-MODEL EVIDENCE COLLECTION AND WEAK SUPERVISION FOR ENHANCED THREAT DETECTION AND RESPONSE

(71) Applicant: Embed Security, Inc., Reno, NV (US)

(72) Inventors: Jeffrey Johns, Leesburg, VA (US); Seth Summersett, Reno, NV (US)

(73) Assignee: Embed Security, Inc., Reno, NV (US)

(21) Appl. No.: 19/412,835

(22) Filed: Dec. 8, 2025

Related U.S. Application Data
(60) Provisional application No. 63/728,802, filed on Dec. 6, 2024.

(51) Int. Cl. G06F 21/55

(52) U.S. Cl. CPC G06F 21/554; G06F 2221/034

(57) ABSTRACT

A computer-implemented method for generated machine-derived cybersecurity threat determinations is disclosed. A classification model executed by a distributed cybersecurity service processes cybersecurity alert data to produce a classification output. A classification-indexed investigation-step specification is retrieved from memory and used to access evidence sources to form a machine-readable evidence corpus. A question-conditioned inference model generates model-derived answers to investigative questions by operating on vectorized representations of the evidence and questions, producing structured question-and-answer (Q&A) data elements. A feature-extraction operation encodes the Q&A data into a feature vector that is evaluated by a weak-supervision predictive model to compute probabilistic outputs for the investigative questions. An investigative conclusion is generated based on the probabilistic outputs, and a natural-language generation module produces a machine-generated summary describing the evidence, Q&A data, and investigative conclusion together with recommended cybersecurity response actions.

### CROSS-REFERENCE TO RELATED APPLICATIONS

This application claims the benefit of U.S. Provisional Application number 63/728,802, filed 6Dec. 2025, which is incorporated in its entirety by this reference.

### TECHNICAL FIELD

This invention relates generally to the cybersecurity field, and more specifically to a new and useful automated alert investigation in the field of threat detection and response.

### BACKGROUND

In recent years, organizations have faced an increasing number of cybersecurity threats that require constant monitoring and quick response. Security analysts are often overwhelmed by the volume of alerts generated by security information and event management (SIEM) systems, endpoint detection and response (EDR) solutions, and other security platforms. This volume of alerts, combined with the limited availability of trained security personnel, leads to challenges in identifying and mitigating genuine threats in a timely manner. Consequently, many alerts go uninvestigated, leaving organizations vulnerable to undetected attacks.

Current automated security solutions often rely on single-model approaches to classify and manage alerts. These systems tend to struggle with noisy or incomplete data, which can result in high false positive rates and unreliable conclusions. Additionally, traditional models generally lack the flexibility to emulate the nuanced decision-making process of human analysts. Thus, existing systems fail to meet the industry's need for reliable, scalable, and efficient alert investigation tools.

To address these challenges, this invention presents a compound AI system designed for automated alert investigation. This system utilizes multiple artificial intelligence (AI) and machine learning (ML) models, each specialized to handle different aspects of the investigation process. The system can autonomously triage, investigate, and summarize alerts with a high degree of accuracy and transparency. It incorporates weak supervision techniques, allowing the system to handle noisy and unlabeled data more effectively, and provides context-driven responses that enhance its reliability.

This compound AI system ultimately allows security teams to streamline alert investigations, reducing the burden on human analysts and enabling them to focus on high-priority threats. As a result, organizations can improve their overall security posture by quickly identifying and responding to potential threats in a scalable and cost-effective manner.

### BRIEF SUMMARY OF THE EMBODIMENTS

In one embodiment, a computer-implemented method for accelerated cybersecurity threat detection includes operating a remote cybersecurity service implemented by distributed computers to generate a cybersecurity alert classification selected from multiple predetermined classifications based on cybersecurity alert data associated with a subscriber. The embodiment further includes accessing, from memory storing multiple cybersecurity investigation instructions, a classification-indexed investigation set of instructions associated with the generated alert classification; forming a corpus of evidence by accessing one or more evidence sources identified by the investigation instructions; generating, for a plurality of investigative questions associated with the investigation instructions, corresponding model-generated answers that form question-and-answer (Q&A) pairs by applying an automated analysis model to the corpus of evidence; implementing a feature-extraction that encodes each investigative question and the corresponding model-generated answer into machine-readable feature values suitable for a weak-supervision predictive model; extracting a feature set comprising the feature values; applying the weak-supervision predictive model to compute probabilistic outputs for each investigative question; determining an investigative conclusion from the probabilistic outputs; and producing, using a natural-language generation module, a machine-generated summary describing the evidence accessed, the Q&A pairs generated, the investigative conclusion, and system-generated recommended response actions.

In another embodiment, the method includes retrieving the classification-indexed investigation instructions by accessing a classification-to-investigation index stored in memory, where the index maps each cybersecurity alert classification to a machine-readable investigation-step specification defining ordered evidence-access operations and corresponding investigative questions.

In one embodiment, generating model-generated answers includes executing a question-conditioned inference model that accepts as inputs a representation of the investigative question and a bounded subset of the evidence corpus, and outputs an answer token or answer confidence value that forms the corresponding Q&A pair.

In one embodiment, applying the weak-supervision predictive model includes combining the feature values of the feature set using labeling functions or heuristics encoded within the model, where each labeling function evaluates correlations among the feature values to generate probabilistic outputs for the investigative questions.

In another embodiment, the method includes invoking an autonomous artificial-intelligence agent after generating the alert classification, where the agent evaluates the corpus of evidence and intermediate Q&A pairs to determine whether additional evidence is required to complete the investigation.

In one embodiment, when the artificial-intelligence agent determines additional evidence is required, the agent autonomously expands the corpus of evidence by accessing one or more supplemental evidence sources using threat-intelligence or telemetry-access tools exposed through an application programming interface.

In another embodiment, the artificial-intelligence agent generates additional investigative questions not included in the classification-indexed investigation instructions, and the system applies the automated analysis model to the corpus of evidence to produce Q&A pairs corresponding to those additional questions.

In one embodiment, applying the weak-supervision predictive model includes performing an incremental weight-learning process in which weight parameters for features derived from the classification-indexed investigation instructions remain fixed, while weight parameters for features corresponding to AI-generated investigative questions are learned or updated during inference.

In another embodiment, the incremental weight-learning process includes executing, during inference, a real-time fine-tuning cycle that updates weight values associated with dynamically generated investigative features and produces updated probabilistic outputs.

In one embodiment, the incremental weight-learning process includes generating a refined inference result by re-evaluating the feature set using the updated weight values to produce a result more accurate than the result prior to the incremental learning.

In one embodiment, the real-time fine-tuning cycle is repeated until a convergence criterion is satisfied, where the criterion includes a threshold change between successive probabilistic outputs or a stability threshold for a loss function of the weak-supervision predictive model.

In another embodiment, the method includes receiving subscriber-generated investigative questions and corresponding subscriber-generated answers and incorporating those subscriber-generated elements into the plurality of Q&A pairs used to form the feature set.

In one embodiment, subscriber-generated investigative questions are each assigned a subscriber-specified importance value selected from predefined levels, and the importance values are mapped to numerical weights by selecting values from corresponding regions of a weight distribution associated with the weak-supervision predictive model.

In another embodiment, the method includes generating a baseline probabilistic output that excludes subscriber-generated Q&A pairs and comparing it with a probabilistic output generated using the subscriber-generated Q&A pairs to determine whether their inclusion changes any probabilistic output or investigative conclusion.

In one embodiment, a natural-language generation module produces an influence-report segment that identifies differences between the baseline probabilistic output and the subscriber-influenced probabilistic output, including changes to severity determinations, confidence scores, or response actions.

In another embodiment, generating Q&A pairs includes executing a question-evaluation pipeline comprising evidence-selection logic configured to retrieve evidence for a designated investigation step, a model-execution stage applying an analytical model conditioned on the investigative question, and a feature-encoding stage that converts each question and answer into a structured Q&A feature suitable for downstream probabilistic reasoning.

In one embodiment, a question-analysis engine transforms heterogeneous cybersecurity evidence into structured feature values by applying a machine-learning model conditioned on predetermined investigative questions, producing Q&A feature data not derivable through manual inspection.

In another embodiment, a cybersecurity investigation system includes processors and memory storing investigation-step specifications, an automated analysis model, a weak-supervision predictive model, and a natural-language generation module. The system further includes modules for alert classification, investigation-plan retrieval, evidence access, question-analysis, feature extraction, predictive reasoning, investigative conclusion formation, and summary generation.

In one embodiment, a method generates machine-derived cybersecurity threat determinations by executing a classification model to produce alert classification data, retrieving an investigation-step specification, forming an evidence corpus, generating structured Q&A data using a question-conditioned inference model, transforming the Q&A data into a feature vector, applying a weak-supervision predictive model to compute probabilistic outputs, determining an investigative conclusion, and producing an automated summary and recommended response actions.

In another embodiment, executing the question-conditioned inference model includes generating structured Q&A data that reflects a machine-derived transformation of heterogeneous cybersecurity evidence into feature values not obtainable through mere inspection, using conditioning on each investigative-question identifier to incorporate correlations among multiple evidence signals.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates a schematic representation of an investigation planner in accordance with one or more embodiments of the present application; and

FIG. 4 illustrates a schematic representation of a Q&A-based feature extractor and predictor implementing a weak supervision model in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### Overview

Embodiments of the present application relate to a system and method for automating the investigation of security alerts generated within an organization's network. Implementations of the present application may enable security teams to efficiently analyze large volumes of alerts using a series of interconnected artificial intelligence (AI) and machine learning (ML) models. The system may assist in identifying whether alerts indicate potential security threats and provide recommendations for responses, all while minimizing the need for human intervention.

Security alerts are typically generated by monitoring systems that detect unusual activities or potential risks within an organization's infrastructure. Due to the high number of alerts, it may be challenging for security analysts to investigate each alert thoroughly. Embodiments of the present application may address this issue by using a compound AI approach that enables the system to evaluate alerts in a structured manner. The system may employ various machine learning models that simulate the analytical process used by human security analysts, breaking down the investigation into specific steps to ensure a comprehensive review.

The alert investigation process may begin with an initial categorization, where alerts are sorted by type to guide the investigation. Based on the alert category, the system may follow an optimized sequence of investigative steps. Each step may involve collecting relevant evidence, analyzing the data, and answering specific questions that align with typical security assessments. The system may use both rule-based and AI-driven techniques to perform these steps, providing flexibility and adaptability in handling diverse types of alerts.

Implementations of the present application may include the use of large language models (LLMs) and other ML algorithms to automatically answer questions that would traditionally require human judgment. For instance, the system and methods of the present application may be employed to detect impersonation attempts in phishing emails or similar electronic communications by analyzing email headers, sender domains, and message content for indicators of malicious intent. Additionally, the system and methods of the present application may identify anomalous user activity, such as unusual login attempts from geographically distant locations or outside typical working hours. Each answer generated by the system and methods of the present application may be treated as an extracted feature, which may then be further analyzed by a predictive model to assess the nature and severity of the alert.

One feature of embodiments of the present application is the use of weak supervision, which allows the system to learn from data that may be noisy or incomplete. This technique may enable the system to develop insights even when labeled data is scarce, enhancing its ability to handle real-world conditions. Additionally, the system may use summarization techniques to provide security analysts with a clear and concise explanation of the conclusions, allowing them to understand the reasoning behind each recommendation.

By employing this multi-model, data-driven approach, implementations of the present application may improve the speed and accuracy of security alert investigations. The system may relieve security teams from routine tasks, allowing analysts to focus on high-impact alerts that require specialized attention. Organizations may benefit from reduced response times, improved security postures, and more efficient use of resources.

### Technical Benefits

Embodiments of the present application may provide several technical benefits within the realm of automated security alert investigation. By leveraging a compound AI system that incorporates multiple artificial intelligence (AI) and machine learning (ML) models, implementations of the present application may enable automated, accurate, and reliable analysis of security alerts with minimal human intervention. Such a system may address various challenges in cybersecurity alert management, including the high volume of alerts, noisy or incomplete data, and the need for contextual understanding to determine the relevance and severity of threats.

One technical benefit of embodiments of the present application lies in the systematic approach to alert investigation through the use of categorization, evidence gathering, feature extraction, and predictive analysis. The system may begin by categorizing incoming alerts, which guides subsequent investigation steps and enables more efficient processing. Categorization may allow for tailored investigation flows based on alert types, thereby reducing unnecessary processing and enhancing the efficiency of alert analysis.

Embodiments of the present application may further enhance alert investigation through a modular architecture where different investigative steps are handled by specialized machine learning models. Each model may be responsible for a distinct function, such as evidence collection, answering specific security-related questions, or summarizing findings. Such a modular approach may provide a more robust and adaptable framework that can handle various types of security alerts, enabling flexible and efficient processing across diverse data inputs. Furthermore, modularization may facilitate updates or improvements to individual components without requiring substantial changes to the overall system.

Implementations of the present application may employ large language models (LLMs) to perform specific tasks as part of the automated alert investigation process. For example, LLMs may be utilized to seek sensitive information within suspected phishing emails, such as identifying requests for login credentials, payment information, or other sensitive data that may indicate malicious intent. In another application, LLMs may determine anomalous actions in user login behavior by analyzing login patterns, geographic location mismatches, or access attempts outside typical working hours. The threat intelligence extracted by LLMs may be used as features in downstream predictive models, enabling a more comprehensive assessment of alert severity and risk.

A further technical benefit may be achieved through the implementation of weak supervision techniques within the system's predictive models. Weak supervision may enable the system to learn from unlabeled or partially labeled data, addressing real-world scenarios where labeled datasets are often limited or unavailable. By utilizing weak supervision, embodiments of the present application may develop predictive capabilities that can handle noisy or uncertain data without requiring extensive manual labeling. This approach may provide a more practical and scalable solution for cybersecurity operations, enhancing the system's ability to recognize new or evolving threat patterns even in the absence of a fully labeled training dataset.

Implementations of the present application may also incorporate summarization capabilities that provide concise, context-aware explanations of the system's conclusions. By using AI-driven summarization, the system may present security analysts with clear and relevant insights, reducing the time needed for human review and minimizing the risk of oversight. Summarization may thus enable analysts to quickly understand the reasoning behind each alert classification or recommendation, enhancing the transparency and interpretability of the alert investigation process.

Furthermore, embodiments of the present application may improve computational efficiency by employing a streamlined investigation flow, where the system dynamically selects and executes only the investigative steps required based on alert categorization and interim findings. Such an approach may reduce computational overhead by avoiding unnecessary analyses, enabling faster processing and reducing resource consumption. This efficiency may be particularly advantageous in high-volume environments, where a large number of alerts must be processed within constrained timeframes.

In addition, embodiments of the present application may be integrated seamlessly with case management solutions including Security Information and Event Management (SIEM), Endpoint Detection and Response (EDR), Extended Detection and Response (XDR), Security Orchestration, Automation, and Response (SOAR), and other cybersecurity infrastructures. By normalizing and categorizing alerts to work across diverse systems and formats, the system may enhance interoperability and adaptability within various security environments, reducing the need for custom solutions or manual adjustments for each unique alert format.

Accordingly, embodiments of the present application may provide a range of technical benefits, including improved efficiency in alert processing, enhanced adaptability through modular design, sophisticated threat analysis via AI-driven feature extraction and predictive models, and scalability through weak supervision and summarization capabilities. These technical features collectively provide a practical solution to the challenges of automated security alert investigation, supporting reliable threat detection and response in a scalable and resource-efficient manner.

### 1. System for Automated Investigation and Response to Security Alerts

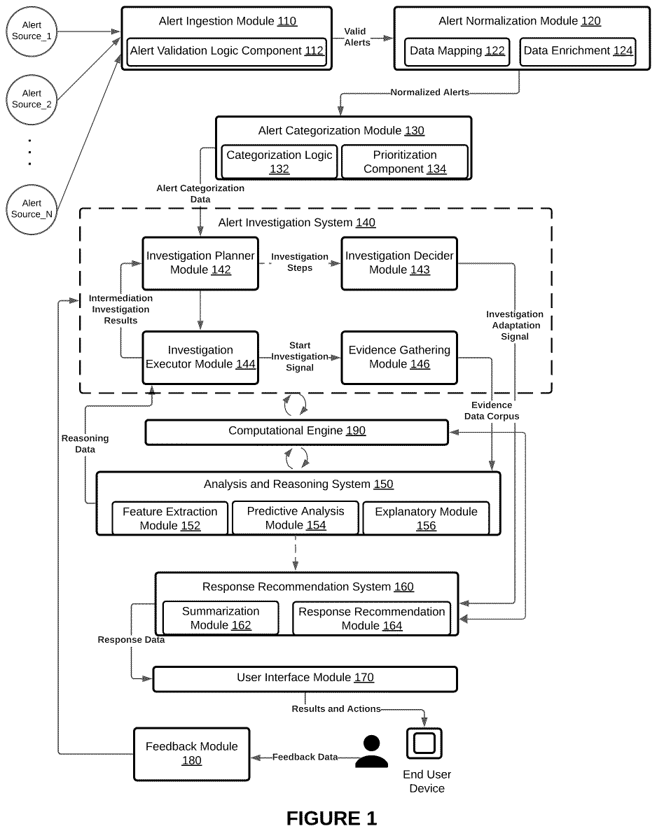

As shown in FIG. 1, system 100 for implementing automated security alert investigation includes alert ingestion module 110, alert normalization module 120, alert categorization module 130, automated alert investigation system 140, analysis and reasoning system 150, response recommendation system 160, user interface module 170, and feedback module 180. System 100 may sometimes be referred to herein as a security alert investigation and response system 100 or an automated security incident investigation and response platform.

System 100 may be implemented using a network of distributed computing resources, which may include cloud-based infrastructure, virtualized environments, and local or remote computer systems interconnected via a computer network. In one or more embodiments, the system may operate on a cloud platform, leveraging the scalable resources of cloud computing environments to support high-volume alert processing and real-time threat detection across multiple client networks.

System 100 may comprise a plurality of computer processors, memory units, data storage devices, and network interfaces to enable efficient execution of the various machine learning, data processing, and analytical operations. Computer processors within system 100 may execute machine learning models, perform complex calculations, and manage the flow of data between system components. Each processor may operate in parallel or asynchronously to handle distinct tasks, such as alert ingestion, feature extraction, predictive analysis, and reasoning.

The memory units within system 100 may store temporary and operational data for quick access by the processors, ensuring efficient handling of data-intensive tasks. Data storage devices, which may include hard drives, solid-state drives, or cloud-based storage solutions, may store both raw and processed security alert data, training data for machine learning models, and historical logs for ongoing system improvement. Storage components may be organized in a distributed database architecture, enabling fast retrieval and scalable storage capabilities to accommodate large volumes of cybersecurity data.

System 100 may include network interfaces for secure communication with external sources, such as SIEM systems, EDR platforms, and third-party threat intelligence services. Network interfaces may allow system 100 to receive security alerts from client environments, access external threat databases for evidence gathering, and communicate with cloud-based or distributed resources to optimize processing and storage efficiency. The computing infrastructure may further include firewall protections, encryption, and other cybersecurity measures to safeguard data and maintain secure communication channels.

Additionally, system 100 may support the deployment of machine learning models across a distributed computing environment, allowing each model to process data in a parallelized manner and ensuring rapid response times. The system may dynamically allocate computing resources based on workload demands, utilizing cloud computing to scale up during high-alert periods and scale down during lower usage, optimizing cost-efficiency and resource management.

System 100 may function to facilitate efficient and accurate automated investigation of security alerts, providing context-aware threat analysis and intelligent response recommendations to support real-time cybersecurity operations.

### 1.10 Alert Ingestion Module

Alert ingestion module 110, sometimes referred to herein as “alert ingestion engine 110,” may be in operable communication with a variety of distinct sources of security alert data, such as security information and event management (SIEM) systems, endpoint detection and response (EDR) solutions, extended detection and response (XDR) platforms, and other monitoring tools that generate security alerts. Alert ingestion module 110 may function to collect and aggregate security alerts from various sources of alert data to initiate the automated alert investigation process in system 100.

In some embodiments, alert ingestion module 110 may be implemented by an alert application programming interface (API) that is programmatically integrated with one or more APIs of the distinct sources of security alert data. The alert API may be configured to interact with native APIs of various security systems, establishing seamless communication with both internal and external alert sources. The alert API may facilitate the automated ingestion of alerts from various formats and communication protocols, ensuring compatibility and continuous data flow into system 100.

Alert ingestion module 110 may include an alert validation logic component 112, which may function to assess the inbound security alert data for quality and relevance. Alert validation logic component 112 may apply predetermined validation rules or criteria to confirm the integrity and completeness of incoming alerts, filtering out irrelevant or redundant alerts. The alert validation process may prevent unnecessary resource usage and improve the accuracy of subsequent investigative actions within system 100.

Additionally, or alternatively, alert ingestion module 110 may be configured to perform preliminary prioritization of alerts based on initial characteristics, such as alert severity level, source credibility, or frequency of occurrence. The prioritization may aid in directing alerts through the investigation process with greater urgency.

Inputs into alert ingestion module 110 may include raw security alert data sourced from various cybersecurity monitoring systems, such as SIEM, EDR, and XDR platforms. Inputs may include alerts detailing potential security events, including unusual login attempts, phishing attempts, or malware detections, as well as contextual information such as IP addresses, timestamps, and affected assets.

Outputs of alert ingestion module 110 may be a standardized and validated stream of security alert data that is passed to alert normalization module 120 for further processing. By structuring incoming alert data, alert ingestion module 110 may enable downstream modules to handle alerts efficiently, contributing to a more accurate and streamlined investigation workflow within system 100.

### 1.20 Alert Normalization Module

Alert normalization module 120, sometimes referred to herein as “normalization engine 120,” may function to standardize the format of security alert data received from alert ingestion module 110. Given the diversity of security systems, each with distinct data formats and naming conventions, alert normalization module 120 may transform incoming alerts into a uniform structure that can be consistently processed by downstream modules within system 100.

In some embodiments, alert normalization module 120 may utilize a set of predefined normalization rules or templates to map fields from various security alert sources to a standardized format. For example, alert normalization module 120 may transform different field names used by various vendors, such as “src_ip” in one system and “ipv4” in another, into a common field name, such as “source IP address.” Normalization may ensure that subsequent analysis modules have a unified view of all alert data, regardless of its source.

Alert normalization module 120 may include a data mapping component 122, which may function to identify and convert non-standardized fields into the standardized format used by system 100. The data mapping component 122 may apply mapping rules to incoming alert data, translating proprietary or vendor-specific fields and values to conform with a common data schema. The configuration may allow alert normalization module 120 to support seamless integration of new data sources by applying existing or customized mapping rules.

Additionally, or alternatively, alert normalization module 120 may optionally include a nominal data enrichment component 124, which may function to supplement the alert data with additional contextual information during a normalization process. For instance, if an alert lacks certain metadata, such as geographic location of an IP address, the data enrichment component 124 may retrieve the contextual information from external threat intelligence sources or internal databases. The nominal data enrichment process may provide greater context for each alert, enabling more informed decision-making in subsequent modules.

It shall be recognized that in a preferred implementation enhanced data enrichment may be explicitly performed in one or more investigative steps (e.g., S230-S250) rather than as part of or in addition to the normalization process executed by alert normalization module 120. During each investigation step, relevant data may be collected and enriched based on the specific requirements of that step. For example, when analyzing a suspected phishing email, the system may retrieve domain reputation data, perform header analysis, and consult external threat intelligence databases as part of the investigation workflow. Similarly, when evaluating anomalous login behavior, the system may enrich data by correlating IP addresses with geographic locations or assessing prior activity patterns associated with the user. By embedding data enrichment directly within investigation steps, the system can ensure that enrichment is contextually relevant and tailored to the specific alert under investigation, enhancing the accuracy and reliability of the resulting analyses.

Inputs into alert normalization module 120 may include the validated and prioritized security alert data provided by alert ingestion module 110. Input data may encompass a variety of alert types, such as login anomalies, phishing attempts, and malware detections, each with unique data structures and metadata.

Implementations of the present application may include normalization of alerts into a proprietary data model, enabling downstream processing to operate in a vendor-agnostic manner. By decoupling downstream processing from vendor-specific formats, the system may support alerts from multiple cybersecurity platforms, such as CrowdStrike® and SentinelOne®, two Endpoint Detection and Response (EDR) solutions, using the same alert processing code. This vendor-agnostic approach reduces the complexity of integrating new alert sources and ensures consistent processing regardless of the source system, enhancing the scalability and flexibility of the overall system.

### 1.30 Alert Categorization Module

Alert categorization module 130, sometimes referred to herein as “categorization engine 130,” may function to categorize security alerts based on alert type, source, severity, or other relevant characteristics. Categorization may provide structure and prioritization within the alert investigation process, enabling downstream modules to follow tailored investigative paths suited to each alert category within system 100.

In some embodiments, alert categorization module 130 may be implemented using rule-based logic, machine learning algorithms, or a combination of both. For example, rule-based logic may assign alerts to specific categories based on predefined criteria, such as keywords in the alert description, source device type, or specific alert indicators. Machine learning algorithms may analyze alert metadata and features to classify alerts dynamically, providing flexibility in handling new or evolving alert types.

Alert categorization module 130 may include a categorization logic component 132, which may function to evaluate the properties of each incoming alert and assign a corresponding category label. Categorization logic component 132 may consider attributes such as alert severity, detection source, event type, and historical data patterns in determining the appropriate category. The categorization may allow system 100 to recognize patterns across alerts and adapt categorization strategies as new information becomes available.

Additionally, or alternatively, alert categorization module 130 may include a prioritization component 134, which may assign a prioritization level to each categorized alert. Prioritization may be based on factors such as potential impact, urgency, or confidence level. For instance, alerts flagged as “high severity” may receive a higher priority, guiding subsequent investigative actions to address alerts more promptly. Prioritization may help system 100 allocate resources effectively, ensuring that alerts posing greater risk receive timely attention.

Inputs into alert categorization module 130 may include normalized and enriched alert data provided by alert normalization module 120. Input data may encompass various alert details, such as event type, detection source, severity level, and associated metadata.

The output of alert categorization module 130 may be a structured and prioritized set of alerts, each labeled with a specific category and prioritization level. The categorized alerts may be passed to automated alert investigation system 140, where category-specific investigation workflows may be initiated. By categorizing and prioritizing alerts, alert categorization module 130 may enhance the efficiency of downstream processes within system 100, supporting a targeted and efficient approach to alert investigation and response.

### 1.40 Automated Alert Investigation System

Automated alert investigation system 140, sometimes referred to herein as “alert investigation engine 140,” may function to conduct a structured, multi-step investigation for each categorized alert. Automated alert investigation system 140 may evaluate the alert data, gather relevant evidence, and apply analysis techniques to determine the potential threat level and recommend appropriate responses within system 100.

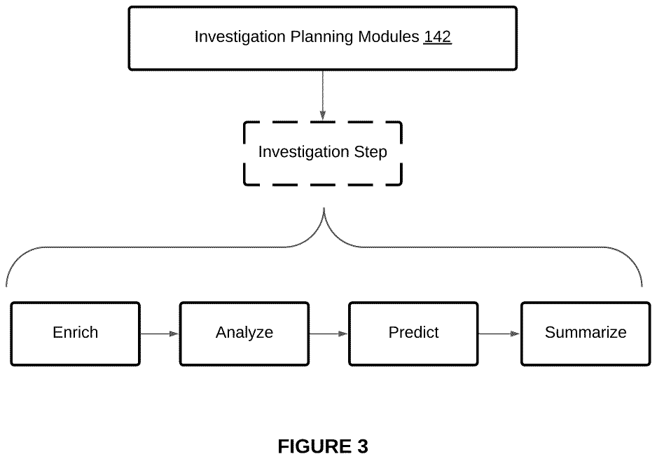

Automated alert investigation system 140 may include investigation planner module 142 and investigation decider module 143, each performing specific functions within the alert investigation process. Investigation planner module 142 may determine the sequence and structure of investigative steps for each alert category, as shown in FIG. 3. Based on the category label and prioritization level assigned by alert categorization module 130, investigation planner module 142 may generate a plan represented as a directed acyclic graph (DAG) or other workflow structure. The plan may specify the investigative actions to be performed and the order in which they should be executed. In some embodiments, investigation planner module 142 may use rule-based decision logic or machine learning models to define optimized investigation workflows tailored to each alert type. For example, an alert categorized as malware may have an investigation plan focused on retrieving file hashes, checking IP reputation, and scanning endpoint logs.

Investigation decider module 143 may evaluate findings at each step of the investigation and make real-time decisions regarding the progression of the investigation. For instance, if intermediate results indicate an escalated risk level or confirm benign activity, investigation decider module 143 may choose to terminate, escalate, or modify the investigation path accordingly. By continuously assessing evidence, investigation decider module 143 may help ensure efficient allocation of resources, focusing investigative efforts on high-risk indicators and adjusting the workflow based on the alert's evolving context. The interaction between investigation planner module 142 and investigation decider module 143 allows automated alert investigation system 140 to implement an adaptive investigation strategy, enhancing responsiveness to complex or rapidly changing security events.

Accordingly, system 100 may include automated alert investigation system 140, which orchestrates the investigation of each alert through a structured yet adaptive workflow. Investigation planner module 142 may create an initial investigation plan, outlining sequential actions tailored to the alert's characteristics. Investigation decider module 143 continuously assesses evidence obtained during each investigative step, dynamically adjusting the investigation path based on intermediate findings. Collaboration between investigation planner module 142 and investigation decider module 143 allows automated alert investigation system 140 to implement responsive and efficient investigations, focusing resources on high-risk alerts while reducing redundant analysis on low-priority alerts.

Investigation executor module 144 may be responsible for executing the investigative steps defined by investigation planner module 142. Investigation executor module 144 may manage the execution of both synchronous and asynchronous operations, allowing steps to be conducted in parallel where applicable. For example, investigation executor module 144 may initiate evidence collection tasks, run data analysis, and process background checks concurrently to reduce investigation time. Additionally, investigation executor module 144 may monitor the completion status of each step and ensure that results are available for subsequent processing steps.

### Autonomous AI-Agent Operations

In some embodiments of the present application, an investigation executor module 144 may be configured to execute a sequence of investigation steps associated with a given normalized alert. The investigation executor module 144 may receive from an investigation planner module 142, a directed acyclic graph (DAG) defining the set of investigation steps and the dependencies between those steps. The executor may initiate, monitor, and complete the execution of such steps, including synchronous steps, asynchronous steps, and steps requiring external data retrieval.

In additional embodiments of the present application, the investigation executor module 144 may further include logic for coordinating and executing a set of autonomous AI-agent-driven enrichment and analysis operations that augment the security subject matter expert (SME)-defined investigation steps. In these embodiments, the investigation executor module 144 may invoke an autonomous AI agent after the completion of one or more SME-authored enrichment and analysis routines.

The autonomous AI agent may be provided with (i) the SME-generated enrichment data, (ii) the SME-generated question-and-answer pairs, and (iii) contextual information about the alert category, alert metadata, and prior investigation outputs. Based on this information, the AI agent may automatically generate additional enrichment operations and additional investigative questions without requiring prior enumeration of such questions by the SME.

### AI-Agent-Driven Enrichment Execution

In certain embodiments, the investigation executor module 144 may provide the autonomous AI agent with access to a plurality of threat intelligence and telemetry-retrieval tools implemented using a model context protocol (MCP). Such tools may include external intelligence sources and provider interfaces capable of gathering data related to IP addresses, domain names, URLs, email addresses, file hashes, system processes, endpoint telemetry, network flow logs, and security event sequences.

The investigation executor module 144 may schedule the execution of the AI agent's proposed enrichment operations in parallel or in accordance with dependency criteria defined in the investigation DAG. The executor may then collect and store results generated by the AI agent, including evidence objects, structured metadata, unstructured data, or any combination thereof, and may expose this enriched evidence to a downstream Q&A feature extraction module 152.

### AI-Agent-Generated Question and Answer Execution

In further embodiments of the present application, the investigation executor module 144 may also trigger execution of AI-agent-generated investigative questions. The executor may pass (i) the relevant enrichment evidence, (ii) the generated question text, and (iii) contextual information to a large language model or other automated analysis mechanism to produce answers that are consistent with the evidence. The executor may then record the resulting question-and-answer pairs as dynamically generated Q&A features.

The investigation executor module 144 may mark these AI-generated Q&A pairs as distinct from SME-authored Q&A pairs, enabling downstream model components to treat such features differently if weighting or provenance metadata is required.

In various embodiments, when AI-agent-generated investigative questions are created during inference, the investigation executor module 144 may trigger a real-time incremental model-update procedure implemented within predictive analysis module 154 and machine learning and computational methods module 190. In such embodiments, the system may freeze weak-supervision feature-weight parameters associated with SME-authored investigative questions and determine weight parameters associated with AI-agent-generated investigative questions only. Investigation executor module 144 may coordinate delivery of dynamically generated Q&A feature data and associated schema metadata to the incremental learning subsystem and may update feature-schema references associated with the ongoing investigation, while predictive analysis module 154 maintains and updates the underlying weak-supervision model state.

The investigation executor module 144 implements a hybrid system that combines SME-authored investigative workflows with AI agent driven dynamic enrichment and investigative questions, enabling real-time augmentation of expert knowledge with contextually relevant investigative tasks. In some embodiments of the present application, investigation executor module 144 may provide to an autonomous AI agent the SME-generated enrichment evidence and the SME-generated question-and-answer (Q&A) features produced during execution of the SME-authored investigation-step specification. Upon receiving these SME-authored outputs as an initial investigative state, the AI agent may evaluate the evidence, Q&A pairs, and alert context to determine whether additional investigative questions are warranted. Based on this evaluation, the AI agent may generate one or more new investigative questions and may request additional evidence to support those new questions. Investigation executor module 144 may therefore coordinate (i) the delivery of SME-generated investigative outputs to the AI agent and (ii) the subsequent execution of AI-agent-generated investigative tasks, including retrieval of additional evidence sources and generation of corresponding model-generated answers. Such embodiments may allow the investigation process to adapt in real time to alert-specific evidence patterns, thereby improving the completeness and accuracy of the automated investigation without requiring reauthoring of investigative logic by the SME.

In some embodiments of the present application, an evidence collection module 146 may be configured to gather evidence associated with a normalized and categorized alert. The evidence collection module 146 may obtain information from local and remote data sources, including threat intelligence repositories, internal telemetry systems, event logs, endpoint detection agents, and historical alert data. The module may structure, normalize, and store the evidence for downstream analysis performed by an investigation executor module 144 and an analysis and reasoning system 150.

That is, in some embodiments of the present application, the system 100 (or cybersecurity service) may provide the autonomous AI agent with the SME-generated enrichment evidence and the SME-generated question-and-answer (Q&A) features produced for the alert. Upon evaluating this initial investigative state, the AI agent may determine that the evidence or the SME-generated Q&A pairs do not fully address certain investigative dimensions of the alert or the AI agent detects an evidentiary gap in the corpus of evidence of the SME. Based on this evaluation, the AI agent may automatically generate one or more additional investigative questions that were not included in the SME-authored investigation-step specification. After generating these additional investigative questions, the system may execute corresponding investigative actions, including accessing any additional evidence required to answer the newly generated questions and applying an automated analysis model to produce model-generated answers. The resulting dynamically generated Q&A pairs may then be incorporated into the feature set used for downstream probabilistic reasoning.

Evidence collection module 146 may gather relevant contextual data from external sources and internal sources via intelligent integrations between at least the evidence collection module 146 and the various external and internal sources. Intelligent integrations may enable system 100 to access and utilize client-specific data sources, supporting context-specific decision-making tailored to each client or subscriber to the service implementing system 100. Examples of intelligent integrations may include gathering data from a vulnerability scanner to identify potential exposures relevant to an alert, retrieving information from an asset management database to determine the importance or sensitivity of the affected resource, consulting internal wiki pages containing the client's standard operating procedures to understand expected response protocols, querying an internal ticketing system for related incidents or historical context, and interacting directly with an end user via communication platforms, such as Slack, using a large language model to ask clarifying questions, such as, “Did you log in last night at 2 am from China?” Evidence collection module 146 may aggregate the outputs from these integrations, providing enriched, client-specific evidence to downstream modules for analysis and decision-making. By integrating information from internal systems, evidence collection module 146 may ensure that the investigative steps and recommendations are tailored to the specific operational context of each client.

### Custom-Authored Investigation Q&As

In additional embodiments of the present application, the evidence collection module 146 may also process subscriber-authored investigative questions and associated answers when such data is provided as part of the subscriber's customized investigation configuration. Subscribers may specify investigative questions that reflect environment-specific detection requirements, internal security policies, or organization-specific interpretations of risk. When a subscriber submits an investigative question and an associated answer source or answer value, the evidence collection module 146 may treat these as first-class evidence-bearing artifacts. The module may pair the subscriber-provided question with the relevant evidence or answer content and produce a structured representation that can be consumed by a feature extraction module.

In certain embodiments, the evidence collection module 146 may also apply subscriber-designated importance levels to subscriber-generated evidence and questions. Subscribers may assign such questions a qualitative importance value, such as Low, Medium, or High, which may indicate the relative significance the organization attributes to the investigative signal represented by the question. The evidence collection module 146 may therefore tag the evidence and its corresponding question with metadata reflecting the subscriber-specified importance level, enabling downstream components to treat these investigative elements in accordance with subscriber-defined priorities. This metadata may accompany the evidence as it passes through the system, allowing the predictive and reasoning components to incorporate or highlight the influence of subscriber-defined investigative logic.

In further embodiments, the evidence collection module 146 may maintain provenance attributes distinguishing between SME-authored evidence, AI-agent-generated evidence, and subscriber-provided evidence. This provenance information may support transparency features in the user interface and may also enable the weak supervision system to differentiate how evidence from each source contributes to the investigation. By integrating subscriber-generated evidence in this manner, the evidence collection module 146 may allow the investigation pipeline to reflect subscriber-specific expertise and contextual knowledge, thereby expanding the relevance and adaptability of the automated investigation process.

### Dynamic Evidence Collection

In additional embodiments of the present application, the evidence collection module 146 may also support autonomous AI-agent-initiated evidence-collection operations that supplement SME-authored enrichment steps. After SME-defined enrichment tasks have been executed, the investigation executor may invoke an autonomous AI agent that interacts directly with the evidence collection module 146 to identify additional evidence sources relevant to the alert under investigation. The AI agent may analyze SME-collected evidence, contextual information derived from the alert category, and intermediate results produced during earlier stages of investigation. Based on this information, the AI agent may determine that further evidence is required to answer dynamically generated investigative questions or to refine its understanding of indicators observed in the alert. In certain embodiments, the evidence collection module 146 may expose a set of evidence-gathering tools implemented using a model context protocol (MCP). Through these tools, the AI agent may autonomously retrieve data from a variety of security-relevant sources, such as systems for determining IP reputation, services that provide domain age or WHOIS metadata, systems capable of generating URL screenshots and performing blocklist lookups, file-reputation intelligence services, email-intelligence systems, cloud asset inventories, endpoint detection and response systems, security information and event management logs, or telemetry such as DNS activity, network flow information, or user-authentication events. The evidence collection module 146 may orchestrate these retrieval operations, handle any required authentication or rate-limiting, convert responses into a normalized schema, and store the resulting artifacts within an evidence data corpus accessible to other system components. When the AI agent generates new investigative questions, the evidence collection module 146 may determine whether the evidence already collected is sufficient to support those questions. If additional information is required, the AI agent may request supplementary evidence, and the module may retrieve such evidence through its MCP-enabled toolset. For instance, the module may interact with an EDR provider to retrieve recent host telemetry if the AI agent determines that the investigation requires answering whether a host exhibits indications of credential theft. Similarly, the module may obtain registrar metadata or domain-reputation information if the AI agent generates an investigative question concerning the age or legitimacy of a domain associated with the alert. This dynamic expansion of the evidence set allows the investigation process to adapt to alert-specific conditions that were not anticipated within SME-authored workflows.

The evidence collection module 146 may further annotate all collected evidence with metadata describing its provenance, such that downstream components can distinguish evidence collected as a result of SME-authored enrichment from evidence collected in response to AI-agent-generated enrichment operations or AI-agent-generated investigative questions. A Q&A feature extraction module 152 or explanatory 156 may rely on this provenance data to apply differential weighting or processing logic as needed.

In various embodiments, the evidence collection module 146 may also prepare AI-agent-generated evidence for real-time incremental integration into a weak-supervision model. In such cases, the module may format the evidence into structured fields, typed objects, or contextual blocks that can be consumed by the Q&A generation and feature extraction pipeline. When the AI agent produces new questions during inference, the evidence collection module 146 may identify any missing information required to support those questions, collect the necessary evidence in real time, and provide it to downstream components for feature extraction. Q&A features generated from such evidence may be marked as dynamically generated features that are eligible for incremental weight-learning procedures.

Through these enhancements, the evidence collection module 146 may serve as a hybrid enrichment framework combining SME-authored investigative logic with AI-agent-driven adaptive evidence gathering. This dual structure enables the system to collect and analyze types of evidence not anticipated by human experts, thereby producing investigations that are more complete, contextually responsive, and capable of adapting to evolving threat patterns.

Additionally, or alternatively, evidence collection and feature extraction within automated alert investigation system 140 may implement one or more language models to generate structured question-answer pairs, transforming raw data into features that encapsulate insights about each alert. The Q&A-based feature extraction process enables system 100 to systematically answer predefined security questions, such as ‘Is the IP address associated with previous malicious activity?’ or ‘Does the file hash correspond to known malware?’ The resulting Q&A responses may be used as features in predictive analysis, providing a granular and contextualized view of each alert.

Inputs into automated alert investigation system 140 may include the categorized and prioritized alerts provided by alert categorization module 130. Input data may encompass alert category labels, severity levels, and associated metadata, along with any normalized and enriched alert details.

The output of automated alert investigation system 140 may be a set of investigation findings, including gathered evidence, analysis results, and any identified threat indicators. Outputs may be passed to analysis and reasoning system 150, which may further process the findings to generate insights or recommendations. By conducting a systematic investigation process, automated alert investigation system 140 may provide a structured and comprehensive approach to understanding and evaluating security alerts, enhancing the overall efficiency and accuracy of system 100 in detecting and mitigating potential threats.

### 1.50 Analysis and Reasoning System

Analysis and reasoning system 150, sometimes referred to herein as “analysis engine 150,” may function to analyze the investigation findings generated by automated alert investigation system 140 and apply reasoning to reach conclusions about each alert's nature and potential threat level. Analysis and reasoning system 150 may evaluate features derived from evidence, perform predictive analysis, and utilize explanatorys to provide security insights or recommendations within system 100.

Analysis and reasoning system 150 may include multiple sub-modules, each responsible for specific aspects of the analytical process. Feature extraction module 152 may process the collected evidence and convert raw data into structured features that may be used as inputs for predictive analysis. In some embodiments, feature extraction module 152 may employ machine learning models, such as large language models (LLMs), to answer predefined security questions based on alert context. Each answer may be treated as a feature, enabling system 100 to analyze various aspects of the alert with greater depth.

In some embodiments of the present application, a feature extraction module 152 may be responsible for generating question-and-answer (Q&A) feature data used as input to predictive and explanatorys operating within an automated alert investigation pipeline. The feature extraction module 152 may receive normalized alert data, SME-authored investigative questions, and SME-collected enrichment evidence and may produce structured Q&A feature vectors that represent the analytical state of the investigation. These Q&A feature vectors may capture the semantic content of investigative questions and the corresponding answers derived from evidence, enabling downstream machine-learning models to reason over the collected information.

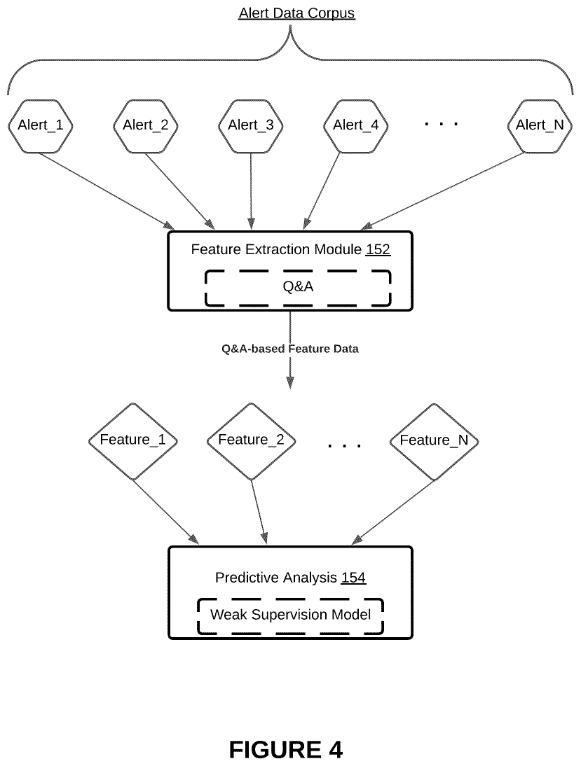

As shown in FIG. 4, in one implementation, feature extraction module 152 may incorporate a Q&A data extraction process, wherein a language models (e.g., an LLM) may be fine-tune trained with investigative questions and answers for each of a plurality of distinct investigative steps for handling an alert. Each investigation step may target a particular aspect of the alert to gather evidence and provide context for subsequent analysis. For example, one investigation step may assess whether an email header contains suspicious characteristics, while another may analyze whether a URL embedded in the email exhibits malicious behavior. Each question addressed by an investigation step may provide critical insights into specific components of the alert, allowing the system to build a detailed and comprehensive understanding. Accordingly, the language model, once fine-tune trained, may function to generate answers to security-relevant or investigative questions of investigative steps. For instance, for a potential phishing alert, system 100 may automatically answer questions such as ‘Does the body or content of the email convey a sense of urgency?’ or ‘Is the sender domain recently registered?’ Each answer, generated by the language model, may be stored as a feature, encapsulating useful context that enhances the downstream automated predictive and automated reasoning processes of system 100. By using Q&A data as features, feature extraction module 152 may deliver a detailed, context-aware representation of each alert, improving system 100's analytical depth and predictive accuracy.

In additional embodiments of the present application, the feature extraction module 152 may also process dynamically generated investigative questions and evidence produced by an autonomous AI agent. After execution of SME-authored enrichment and analysis routines, the investigation executor 144 may transmit the AI agent's newly generated investigative questions, along with any additional evidence collected by the agent, to the feature extraction module 152. The module may treat these dynamically generated questions as first-class investigative features, even though they were not pre-specified during model training or during SME workflow design. In this manner, the feature extraction module 152 may support a hybrid workflow in which static SME-defined questions coexist with adaptive, context-dependent questions created by the AI agent.

When processing dynamically generated questions, the feature extraction module 152 may evaluate the relevant evidence and produce corresponding answers using a large language model or similar automated reasoning mechanism. In some embodiments, the module may provide the language model with a structured bundle of context that includes the question text, the evidence collected by both SME-authored and AI-agent- generated enrichment routines, and any metadata describing the relevance or scope of the evidence. The language model may then generate an answer that reflects the content of the evidence rather than relying on generalized world knowledge. The feature extraction module 152 may store the resulting answer, along with the question text and provenance attributes, as part of a dynamically generated Q&A feature set.

In certain embodiments, the feature extraction module 152 may annotate Q&A features with metadata indicating whether the question was authored by an SME or generated by the AI agent during inference. This attribution metadata may be used by downstream weak-supervision models to treat such features differently during reasoning and prediction. For example, SME-authored questions may reflect stable investigative logic and may correspond to weight values learned during the main model training process, while AI-generated questions may correspond to weight values learned dynamically at inference time. To support such behavior, the feature extraction module 152 may associate provenance information, temporal generation identifiers, and reference tags with each dynamically generated Q&A feature.

The feature extraction module 152 may further support real-time expansion of the feature schema used by downstream weak-supervision models. When the AI agent introduces novel investigative questions, the corresponding Q&A outputs may not align with any preexisting feature weights defined during model training. In these embodiments, the module may prepare the newly generated Q&A features for incremental learning procedures that adjust or extend the weak-supervision model's feature weighting without requiring a full retraining cycle. The feature extraction module 152 may therefore operate as a bridge between dynamically generated investigative content and the fixed or partially fixed feature schema established by the SME-authored investigation design.

In various embodiments, the feature extraction module 152 may ensure that dynamically generated Q&A features are encoded into vectorized formats consistent with the downstream explanatory's input expectations. Such encoding may involve converting question and answer text into structured embeddings, categorical indicators, or syntactic representations that preserve semantic distinctions relevant to threat analysis. The module may then combine SME-authored Q&A features and dynamically generated features into a unified Q&A feature vector, which may be provided to the predictive analysis module 154 and the explanatory module 156.

Through these capabilities, the feature extraction module 152 may enable the investigation system to adapt to the specific conditions of each alert by incorporating new investigative questions and their corresponding answers into the analytical flow without requiring prior enumeration of such questions during system design. This hybrid SME-plus-AI approach may significantly improve the system's ability to identify subtle threat indicators, respond to emerging threat patterns, and generate a more complete and contextually informed feature set for predictive and reasoning stages of the investigation pipeline.

### Subscriber-Generated Investigative Q&As

In some embodiments of the present application, the feature extraction module 152 may additionally support the processing of subscriber-generated investigative questions and answers that supplement the questions and answers generated through SME-authored or AI-agent-driven investigative logic. Subscribers may define their own investigative questions to reflect organization-specific detection requirements, policy constraints, environmental context, or proprietary knowledge about their assets or threat landscape. When such subscriber-authored investigative questions are provided, the feature extraction module 152 may treat these questions as part of the set of analytical inputs for the alert under investigation.

In certain embodiments, subscriber-generated investigative questions may be accompanied by subscriber-provided answers, references to internal evidence sources, or pointers to proprietary telemetry. The feature extraction module 152 may receive these question-and-answer pairs and convert them into structured Q&A feature representations consistent with the system's internal formatting requirements. When subscriber-provided answers require additional processing or evidence correlation, the module may resolve these requirements using the evidence corpus maintained by the evidence collection module 146 or by applying automated analysis mechanisms configured for subscriber-specific evidence sources. The module may therefore ensure that subscriber-generated questions and answers enter the feature space in a structured and interpretable manner.

In additional embodiments, the feature extraction module 152 may incorporate subscriber-specified importance values associated with subscriber-generated investigative questions. Subscribers may assign importance levels such as Low, Medium, or High to indicate the relative priority or evidentiary strength they attribute to each question. The feature extraction module 152 may record these importance designations as metadata associated with the corresponding Q&A features. Rather than mapping these qualitative importance levels to fixed weight values, the system may determine numerical weight values dynamically by analyzing the distribution of weight assignments associated with SME-authored features. For example, Low-importance subscriber features may receive weight values near the lower end of the SME feature-weight distribution, Medium-importance features may be mapped near the centroid of that distribution, and High-importance features may be assigned values near the upper end of the distribution. By deriving numerical weight values in this manner, the system may ensure that subscriber-generated features integrate smoothly into the broader analytical framework without destabilizing the underlying weak-supervision model.

In some embodiments, the feature extraction module 152 may annotate subscriber-generated Q&A features with provenance metadata that distinguishes them from SME-authored or AI-generated investigative content. These provenance markers may support analytic transparency, allowing the system to determine the degree to which subscriber inputs contributed to predictive outcomes or reasoning conclusions. They may also enable the weak supervision model to consider subscriber-generated features separately during the calculation of feature-weight assignments or during the evaluation of conflicting investigative signals.

In further embodiments, the feature extraction module 152 may prepare two parallel feature sets for downstream processing: a first feature set that includes only SME-authored and AI-agent-generated Q&A features, and a second feature set that includes both the standard features and the subscriber-generated features. These parallel feature sets may be provided to two corresponding predictive models or weak-supervision pipelines. The feature extraction module 152 may therefore serve not only as the generator of unified analytical representations but also as the partitioning mechanism through which subscriber-influenced and non-subscriber-influenced analytical paths are maintained, traced, and compared.

Through these capabilities, the feature extraction module 152 may allow the automated investigation system to incorporate subscriber-specific investigative logic into its analytical framework in a controlled, transparent, and technically robust manner. By structuring subscriber-generated Q&A inputs, mapping subscriber-specified importance levels into stable numerical weight values, and producing feature sets suitable for parallel-path analysis, the feature extraction module 152 enables subscribers to embed their operational context directly into the investigation pipeline while preserving the reliability and interpretability of the system's default reasoning behavior.

Additionally, or alternatively, system 100 implementing predictive analysis module 154 may apply machine learning models to the extracted features to generate probabilistic predictions indicating a probative quality of each of the features extracted or derived by the Q&A data extraction process. In one or more embodiments, the probabilistic predictions of predictive analysis module 154 may define additional evidence or features for supporting one or more downstream decisions regarding the alert. The probabilistic predictions generated by predictive analysis module 154 may include confidence scores, providing additional insight into the reliability of each feature predictions of the feature extraction module 152.

In some embodiments of the present application, a predictive analysis module 154 may be configured to receive Q&A feature vectors generated by a feature extraction module 152 and to generate predictions that estimate the likelihood that a particular investigative question should be answered affirmatively or negatively. The predictive analysis module 154 may apply a weak-supervision model that has been trained using labeling functions derived from SME-authored investigative logic, thereby enabling the system to produce probabilistic outputs that reflect correlations among a set of noisy, overlapping, or conflicting Q&A features. These probabilistic outputs may serve as intermediate predictions that support the explanatory's evaluation of whether an alert is benign, malicious, or indeterminate.

In additional embodiments of the present application, the predictive analysis module 154 may further support real-time incorporation of dynamically generated Q&A features produced by an autonomous AI agent during inference. When the AI agent introduces new investigative questions that were not available during the initial model training process, the predictive analysis module 154 may execute an incremental learning procedure in which the weight parameters associated with SME-authored features remain fixed while new weight parameters corresponding to AI-generated features are learned in real time. This incremental approach may preserve the stability of the original model while allowing the system to extend its predictive capabilities to encompass dynamically generated investigative logic.

In some embodiments of the present application, when dynamically generated investigative questions are introduced during inference, the system may update the weak-supervision predictive model by adjusting only the weight parameters associated with the newly generated questions while maintaining the weight parameters associated with SME-authored investigative questions in a fixed state. In this configuration, the weak-supervision model treats the SME-derived feature weights as static baseline parameters that remain unchanged during inference and extends the model's parameter space by learning or estimating new weight values solely for the dynamically generated features. This incremental update procedure allows the system to incorporate additional investigative signals without retraining the full model and without modifying the original SME-derived weight structure.

In various embodiments, the predictive analysis module 154 may operate on a composite Q&A feature vector that includes both SME-authored features and dynamically generated features. After applying weak-supervision techniques to infer label probabilities for each investigative question, the predictive analysis module 154 may produce a probabilistic prediction that reflects the combined influence of the static and dynamic features. The module may retain metadata indicating whether specific contributing features originated from SME-authored content or AI-generated content, enabling downstream reasoning components to differentiate between traditional expert-defined investigative signals and new insights generated autonomously by the AI agent.

In further embodiments, the predictive analysis module 154 may incorporate contextual indicators reflecting the relevance, strength, or provenance of dynamically generated features. These indicators may influence the incremental weight-learning procedure, allowing the system to adjust weight assignments based on the reliability or importance of particular evidence types. In some cases, the model may assign lower initial confidence to AI-generated features until sufficient data is gathered to validate their predictive value, or it may assign higher weight values to AI-generated features that align strongly with existing SME-defined logic.

Through these enhancements, the predictive analysis module 154 may enable the automated alert investigation pipeline to reason over an expanded and dynamically evolving feature space that adapts to new evidence and new investigative questions introduced by the AI agent. This adaptive structure may significantly improve investigative accuracy, particularly in cases where emerging threat behaviors require features that were not anticipated by SMEs during initial model design. By preserving the core SME-authored weight structure while supporting real-time incremental updates, the predictive analysis module 154 may provide a stable yet adaptable predictive framework capable of supporting dynamic and context-aware threat investigations.

In some embodiments of the present application, an explanatory module 156 may be configured to synthesize, organize, and explain the probabilistic outputs generated by the weak-supervision predictive model 154. Explanatory module 156 may aggregate the probabilistic outputs associated with the investigative questions of an investigation step and may determine a step-level or alert-level investigative conclusion based on such aggregated outputs. Explanatory module 156 may further generate structured explanatory data that describes how the underlying feature values and corresponding probabilistic outputs contributed to the investigative conclusion. In this manner, explanatory module 156 functions as an inference-aggregation and explanation-synthesis component that operates on the outputs of the weak-supervision predictive model, rather than as the model that performs the probabilistic reasoning itself.

In some embodiments of the present application, an explanatory module 156 may be configured to evaluate the set of predictions generated by a predictive analysis module 154 and to determine, for each investigative step, whether the overarching investigative question should be answered affirmatively, negatively, or with an indeterminate value. The explanatory module 156 may rely upon a weak-supervision framework in which outputs generated for individual Q&A features are synthesized into a single probabilistic assessment. Such assessments may reflect the system's estimation of whether the alert exhibits characteristics that align with malicious behavior, benign behavior, or behaviors requiring further investigation. The explanatory module 156 may therefore represent the core inference engine responsible for combining Q&A signals into a structured analytical conclusion.

In additional embodiments of the present application, the explanatory module 156 may also incorporate dynamically generated Q&A features produced by an autonomous AI agent during the execution of an investigation. When such dynamically generated features are present, the explanatory module 156 may process them alongside SME-authored features, even when the dynamic features were not available at the time the weak-supervision model was originally trained. The explanatory module 156 may operate on a composite feature vector containing both static SME-authored features and dynamically generated AI-agent features and may treat these sources differently based on metadata provided by upstream modules, including feature provenance, generation time, and contextual relevance.

In certain embodiments, the explanatory module 156 may rely on an incremental weak-supervision update process that enables the system to determine the appropriate weight contributions for AI-generated features without altering the weight assignments associated with SME-authored features. When new Q&A features appear during inference, the system may maintain stability in the SME-informed structure of the explanatory while adjusting only those parameters associated with newly introduced features. This approach may allow the explanatory module 156 to extend its analytical capacity to account for emergent threat indicators or context-specific evidence patterns identified by the AI agent, without degrading previously validated SME-derived reasoning relationships.

In some embodiments, the explanatory module 156 may generate decision metadata that describes the influence of specific Q&A features on the final investigative conclusion. Such metadata may identify the relative weight contributions of SME-authored features and dynamically generated features, illustrate the degree of alignment between the two, or indicate whether dynamically generated features introduced materially new reasoning paths not previously anticipated in the SME-authored investigative logic. This metadata may be consumed by a summarization module or a user-interface module to provide transparency regarding the reasoning process.

In some embodiments of the present application, the module 156 does not modify or retrain any machine-learning parameters but instead operates exclusively on the probabilistic outputs generated by the weak-supervision predictive model 154. Module 156 may aggregate these probabilistic outputs to derive a step-level or alert-level investigative conclusion and may generate explanatory metadata describing how the feature values contributed to the derived conclusion. Any incremental weight updates or learning processes are performed solely within predictive analysis module 154 and computational methods module 190, while module 156 serves as an inference aggregation and explanation-synthesis component that transforms model outputs into structured interpretive results.

In some embodiments of the present application, the predictive analysis module 154 may additionally evaluate subscriber-generated Q&A features in conjunction with the SME-authored and AI-agent-generated features associated with an alert. When subscribers provide their own investigative questions and corresponding answers, either through preconfigured settings or dynamic inputs, the predictive analysis module 154 may incorporate these features into an expanded feature set for use in predictive reasoning. Each such subscriber-generated feature may be accompanied by subscriber-specified importance metadata, which may serve as an initial indicator of the expected relevance or strength of that feature. The system may translate these qualitative importance levels into quantitative weighting values by analyzing the distribution of weight values associated with SME-authored features and assigning numerical values that correspond to the lower, median, or upper regions of that distribution. This mapping process may enable subscriber-generated investigative inputs to integrate smoothly into the system's predictive architecture while maintaining alignment with the established weak-supervision model.

In additional embodiments of the present application, the predictive analysis module 154 may execute two distinct predictive workflows in parallel. In the first workflow, the module may apply the weak-supervision reasoning framework to a feature set composed solely of SME-authored features and dynamically generated AI-agent features. In the second workflow, the module may incorporate the full feature set, including the subscriber-generated questions and answers. By performing predictive analysis over these two parallel feature sets, the system may determine whether the inclusion of subscriber-generated Q&A features influences the probabilistic outcomes associated with any investigative question or alters the model's interpretation of the alert. These parallel computations may enable the system to identify divergences between the standard analytical pathway and the subscriber-influenced pathway, thereby providing a mechanism for transparency and interpretability.

In certain embodiments, the predictive analysis module 154 may further produce metadata describing how subscriber-generated Q&A features affected the predictive outputs. This metadata may include an indication of whether the subscriber-supplied features strengthened or weakened particular investigative conclusions, whether they resolved ambiguities in the SME or AI-agent feature set, or whether they introduced new reasoning paths that were not available in the baseline analysis. The predictive analysis module 154 may also record which subscriber-generated features exerted the greatest influence on the final probabilistic outputs, thereby enabling the system to later display or communicate the impact of subscriber participation in the investigative workflow.

Through these enhancements, the predictive analysis module 154 may support a hybrid analytical framework that allows subscriber-defined investigative logic to coexist alongside SME-authored investigative structures and AI-generated insights. By executing parallel predictive workflows and interpreting subscriber-defined importance values through a stable weighting mechanism, the module may broaden the system's analytical reach while preserving the integrity, reliability, and transparency of its probabilistic reasoning processes.

In some embodiments of the present application, when a subscriber provides an investigative question together with a subscriber-specified importance level, the system may determine a corresponding numerical weight for that investigative question by mapping the qualitative importance level into a region of the numerical weight distribution associated with SME-authored features. The numerical weight selected for the subscriber-generated investigative question may be inserted directly into the feature-weight vector processed by the weak-supervision predictive model 154. In this configuration, SME-derived feature weights remain fixed, and the subscriber-generated feature weights are not learned or adjusted during inference; rather, they are applied as explicit feature-weight parameters used by labeling functions within the weak-supervision model to compute probabilistic outputs. This arrangement enables subscriber-generated investigative questions to influence the probabilistic reasoning process while preserving the stability of the SME-authored model structure.

The explanatory module 156 may interpret customer-generated features using importance values designated by the customer, which may have been previously mapped to numerical weighting parameters that align with the system's weak-supervision framework. These customer-defined weights may influence the reasoning process by adjusting the relative contribution of customer-authored investigative signals to the system's overall understanding of whether the alert exhibits malicious or benign behavior.

In additional embodiments, the explanatory module 156 may operate on predictive outputs generated through two parallel analytical pathways: a baseline pathway that evaluates only SME-authored and AI-generated features, and a customer-influenced pathway that evaluates the full feature set, including customer-generated Q&A. The reasoning module may therefore produce two corresponding sets of reasoning outputs. These outputs may be compared internally to determine whether customer-generated features materially influenced the system's understanding of the alert. If discrepancies are observed between the baseline and customer-influenced reasoning outcomes, the reasoning module may record the nature of such discrepancies, including whether customer-generated evidence resulted in a more severe classification, a downgraded severity, a shift in actionability, or a change in the confidence of the reasoning output.

In certain embodiments, the reasoning module may also generate metadata describing how customer-generated features influenced the reasoning pathway. This metadata may identify specific customer-authored investigative questions that contributed to the final conclusion, describe whether the customer-defined importance values shaped the weighting of the corresponding features, and articulate whether customer-generated Q&A resolved uncertainties that persisted in the baseline feature set. The reasoning module may also record whether the inclusion of customer-generated features introduced reasoning paths that were not previously available, such as enabling conclusions that required context unique to the customer's environment.

In further embodiments, the explanatory module 156 may ensure that the influence of customer-generated features is incorporated into the downstream summarization and user-interface components in a manner that preserves analytical transparency. By maintaining provenance and influence data throughout the reasoning process, the module may enable customers to understand how their inputs contributed to the final investigative outcome and whether those inputs substantively altered the system's interpretation of the alert. Through these enhancements, the explanatory module 156 may support a hybrid reasoning architecture in which SME-authored, AI-generated, and customer-generated investigative logic coexist within a unified framework that allows the system to adapt to unique organizational contexts while maintaining the integrity and reliability of its automated conclusions.

Inputs into analysis and reasoning system 150 may include the investigation findings from automated alert investigation system 140. Input data may encompass structured evidence, extracted features, and any interim conclusions generated during the investigation process.

The output of analysis and reasoning system 150 may be a set of reasoned conclusions, including classifications, confidence levels, and supporting evidence. Outputs may be passed to investigation executor module 144 and/or response recommendation system 160, which may generate response actions based on the conclusions. By applying predictive analysis and reasoning, analysis and reasoning system 150 may provide a nuanced assessment of each alert, supporting an effective and reliable threat response within system 100.

### 1.60 Response Recommendation System

Response recommendation system 160, sometimes referred to herein as “response engine 160,” may function to generate actionable recommendations based on the conclusions provided by analysis and reasoning system 150. Response recommendation system 160 may assess the alert's classification, severity, and associated evidence to formulate appropriate response actions, assisting security analysts in mitigating potential threats efficiently within system 100.

Response recommendation system 160 may include multiple sub-modules, each performing specific functions to enhance the response process. Summarization module 162 may generate a concise summary of the investigation and analysis results, including key evidence, analysis findings, and the final alert classification. Summarization module 162 may use AI-driven language models to transform complex technical data into a clear, easily interpretable format for security analysts. The summary may offer an overview of why an alert was classified in a particular way, highlighting the primary indicators that contributed to the decision, thus enabling analysts to quickly understand the context and significance of each alert.

Response recommendation module 164 may generate specific response actions tailored to the alert's classification and severity level. For example, if an alert is classified as malicious and high-risk, response recommendation module 164 may suggest actions such as isolating the affected device, blocking an IP address, or notifying the appropriate security teams for further investigation. Response actions may vary depending on the alert type, severity, and organizational policies, and response recommendation module 164 may consider these factors when determining appropriate actions. In some embodiments, response recommendation module 164 may allow response actions to be customized or prioritized based on feedback received from analysts via feedback module 180.

Inputs into response recommendation system 160 may include the reasoned conclusions and supporting evidence provided by analysis and reasoning system 150. Input data may include alert classifications, confidence levels, supporting features, and associated metadata.

The output of response recommendation system 160 may be a set of recommended response actions along with a summary of the alert investigation. Outputs may be displayed to security analysts through user interface module 170, allowing analysts to view suggested actions and review the supporting context behind each recommendation. By providing clear and actionable guidance, response recommendation system 160 may support an effective and timely response to security threats, enhancing the overall resilience of system 100 in managing cybersecurity incidents.

### 1.70 User Interface Module

User interface module 170, sometimes referred to herein as “UI engine 170,” may function to present alert investigation results, recommended response actions, and supporting information to security analysts in an accessible and intuitive format. User interface module 170 may facilitate interaction between analysts and system 100, allowing analysts to review, interpret, and act upon the insights generated by the alert investigation process.

User interface module 170 may include various components that enhance the user experience and support efficient navigation of alert data. One function of user interface module 170 may be to transparently display investigative steps performed as part of the automated investigation process. Each investigative step may be associated with specific investigative actions, investigative questions, and corresponding answers generated by system 100. The structured representation of investigative steps within the user interface may enable security operations center (SOC) analysts to review the evidence, insights, and intelligence gathered during each step of the investigation.

Accordingly, in such embodiments, by clearly presenting the investigative steps, including the questions addressed (e.g., “Is the email header suspicious?” or “Does the body of the email convey a sense of urgency?”) and the corresponding answers, user interface module 170 may provide transparency into the automations performed by system 100. Analysts may be able to quickly determine which steps have been completed, what evidence has been collected, and what conclusions have been drawn. This structured approach may allow analysts to bypass earlier investigative steps and focus directly on investigative steps of interest, such as step 12 instead of starting at step 1, enabling more efficient workflows and prioritization of effort.

In addition to displaying investigative steps, user interface module 170 may organize summaries generated by response recommendation system 160, including key evidence, classifications, and recommended actions. Visual elements, such as icons, color-coded indicators, and prioritized lists, may be employed to emphasize alerts and guide analysts in prioritizing their responses. By combining transparency around investigative steps with intuitive visualizations, user interface module 170 may facilitate an efficient and user-friendly investigative experience.

Additionally, user interface module 170 may include an interactive investigation panel that allows analysts to explore deeper layers of information as needed. For instance, the investigation panel may offer access to detailed evidence collected by automated alert investigation system 140, such as IP reputation data, domain characteristics, or historical threat patterns. Analysts may be able to expand or collapse specific sections to view the underlying data associated with each alert, providing flexibility in how information is reviewed.

User interface module 170 may also support feedback functionality, allowing analysts to input their assessments or adjustments based on observed results. Feedback provided by analysts may be directed to feedback module 180, enabling system 100 to incorporate real-world insights and refine its models over time. The feedback feature may support continuous improvement and adaptation of system 100, aligning its outputs more closely with the needs of security teams.

In some embodiments of the present application, the user interface module 170 may further support the presentation of information related to customer-generated evidence and customer-authored investigative questions and answers. When customers contribute their own Q&A features or evidence sources, the user interface may display these elements alongside SME-authored and AI-generated content in a manner that allows analysts to understand the origin, role, and priority of each investigative signal. The interface may therefore provide labeled visual indicators or metadata fields that distinguish customer-defined features from other feature categories and may present the customer-specified importance levels so that analysts can observe how organizational priorities or contextual insights shape the system's reasoning process.

In additional embodiments, the user interface module 170 may be configured to display the output of two parallel reasoning or prediction pathways: a baseline pathway that excludes customer-generated investigative content, and a customer-influenced pathway that incorporates customer-generated Q&A features. When differences exist between the outputs of these two pathways, the interface may highlight the points of divergence. This may include presenting side-by-side representations of severity assessments, actionability determinations, or probability scores, accompanied by indicators that show which conclusions were altered due to the inclusion of customer-generated features. By surfacing these differences, the interface may provide analysts with enhanced visibility into the degree to which customer-defined investigative logic influenced the investigative outcome.

In certain embodiments, the user interface module 170 may also display detailed influence summaries that describe how customer-generated Q&A features affected the predictive and reasoning outputs. These summaries may specify whether particular customer-generated questions contributed materially to the final classification, whether customer-defined importance levels amplified or attenuated the weight of certain evidence signals, and whether customer-generated reasoning paths helped resolve ambiguities present in the SME or AI-agent-generated investigation. The interface may additionally present provenance details for each feature, enabling analysts to trace the investigative lineage from evidence to Q&A feature to predictive influence to reasoning outcome.

In further embodiments, the user interface module 170 may provide interactive elements that allow customers to explore the reasoning process, including the relative impact of their own Q&A features in relation to SME-authored or AI-generated logic. For example, the interface may allow users to toggle the display of customer-generated content, compare hypothesis pathways, or view expanded explanations indicating why certain features had a strong or weak influence on an alert's classification. Through these transparency and exploration capabilities, the user interface module 170 may strengthen trust in the automated investigation process by making visible the specific ways in which customer contributions shaped the system's analytical conclusions.

Through these extensions, the user interface module 170 may provide a comprehensive transparency layer that allows customers to understand not only the results of the automated investigation but also the role their own investigative logic played in shaping those results. By presenting customer-generated evidence, Q&A features, weight assignments, and influence metrics in an intuitive and interpretable manner, the module may enhance the overall usability, explainability, and trustworthiness of the automated alert investigation system.

Inputs into user interface module 170 may include the summarized investigation results and recommended actions from response recommendation system 160, as well as any additional contextual data from other modules within system 100. Input data may encompass classifications, confidence scores, evidence summaries, and metadata associated with each alert.

The output of user interface module 170 may be a user-friendly display that presents relevant information to security analysts, supporting effective decision-making and threat mitigation. By organizing data in a clear and interactive format, user interface module 170 may enhance the efficiency of the alert investigation process, enabling security teams to respond to threats in a timely and informed manner within system 100.

In one or more embodiments, user interface module 170 may provide an interactive investigation panel, allowing analysts to explore additional details of each recommended action and access the underlying evidence or reasoning. For example, analysts may have the option to review the confidence score, key features, or specific indicators that contributed to the recommendation, enabling them to make an informed decision on whether to follow the proposed response. The user interface may also support functionality for analysts to execute certain actions directly from the interface, such as blocking an IP address or isolating a device, enhancing workflow efficiency by consolidating investigation and response capabilities within a single platform.

### 1.80 Feedback Module

Feedback module 180, sometimes referred to herein as “feedback engine 180,” may function to capture, process, and integrate feedback from security analysts to refine and improve the predictive accuracy and relevance of system 100 over time. Feedback provided by analysts regarding alert classifications, evidence relevance, and recommended responses may enable system 100 to adapt to changing threat patterns and improve model performance.

In one or more embodiments, feedback module 180 may collect feedback through user interface module 170, where analysts may input assessments or adjustments based on observed results. Feedback may include reclassification of alerts, notes on evidence significance, or additional insights on recommended actions. Feedback module 180 may process the input, identifying trends or recurrent adjustments to enhance the alignment of system-generated conclusions with human expert judgment.

Feedback module 180 may include a feedback processing component, which analyzes feedback data to detect patterns or discrepancies between system recommendations and analyst responses. For example, if analysts frequently modify a particular alert classification, the feedback processing component may flag the area as requiring model refinement. Feedback module 180 may aggregate the data to create a valuable dataset for retraining and adjusting models within predictive analysis module 154, explanatory module 156, and other components of system 100.

In addition to weak supervision methods, feedback module 180 may support supervised learning if labeled data becomes available. In such cases, feedback data may be treated as labeled input to optimize model training. Feedback module 180 may also include a model refinement component, which may apply both supervised and weakly supervised learning objectives to improve system accuracy. By periodically updating model parameters based on aggregated feedback, system 100 may adapt to emerging security threats, novel alert patterns, and analyst preferences.

Outputs from feedback module 180 may include refined model parameters, updated decision-making criteria, and improved model weighting based on feedback-driven insights. These outputs may be integrated across system 100, enhancing the performance of modules such as alert categorization module 130, predictive analysis module 154, and response recommendation module 164. Feedback module 180 may thus support an adaptive and self-improving system, enabling real-time adjustments to align predictive capabilities with organizational needs and current threat landscapes.

### 1.90 Computational Engine

Machine learning and computational methods module 190, sometimes referred to herein as “computational engine 190,” may function as an underlying component that supports the various sub-modules within system 100, enabling complex data analysis, prediction, and decision-making processes. Module 190 may incorporate a variety of machine learning models and algorithms, tailored to enhance the capabilities of each component in system 100.

The machine learning models and ensemble models utilized by machine learning and computational methods module 190 may employ any suitable learning approach, including, but not limited to, one or more of: supervised learning, such as logistic regression, back-propagation neural networks, random forests, and decision trees; unsupervised learning, such as the Apriori algorithm or K-means clustering; semi-supervised learning; reinforcement learning, such as Q-learning and temporal difference learning; and weak supervision algorithms, which may allow system 100 to train models on noisy, incomplete, or limited labeled data. Weak supervision may be particularly beneficial in scenarios where labeled data is scarce, enabling system 100 to generate accurate predictions and classifications despite data limitations.

Weak supervision techniques employed by machine learning and computational methods module 190 may include one or more of the following algorithms and frameworks: data programming, which involves generating labeling functions to weakly label large datasets; weak supervision models, which allow for the creation of weakly labeled training sets by combining multiple heuristic labeling sources; generative modeling for label synthesis, which combines multiple noisy sources to create probabilistic labels; multi-instance learning, where labels are assigned to groups of instances rather than individual instances; and self-training algorithms, which iteratively use model predictions to label unlabeled data. These weak supervision methods may enhance system 100's ability to generalize from limited labeled data, improving its performance across alert categorization, feature extraction, and predictive analysis tasks within system 100.

In one or more embodiments, each sub-module within system 100 may implement any one or more of the following methods, but should be limited to implementing the following methods including: regression algorithms, such as ordinary least squares, logistic regression, stepwise regression, multivariate adaptive regression splines, and locally estimated scatterplot smoothing; instance-based methods, such as k-nearest neighbors, learning vector quantization, and self-organizing maps; regularization methods, such as ridge regression, least absolute shrinkage and selection operator (LASSO), and elastic net; decision tree learning methods, such as classification and regression trees, iterative dichotomiser 3, C4.5, chi-squared automatic interaction detection, decision stumps, random forests, multivariate adaptive regression splines, and gradient boosting machines; Bayesian methods, such as naïve Bayes, averaged one-dependence estimators, and Bayesian belief networks; kernel methods, such as support vector machines, radial basis functions, and linear discriminant analysis; clustering methods, such as k-means clustering and expectation-maximization; association rule learning algorithms, such as Apriori and Eclat algorithms; artificial neural network models, such as Perceptrons, back-propagation methods, Hopfield networks, self-organizing maps, and learning vector quantization; deep learning algorithms, such as restricted Boltzmann machines, deep belief networks, convolutional networks, and stacked auto-encoders; dimensionality reduction methods, such as principal component analysis, partial least squares regression, Sammon mapping, multidimensional scaling, and projection pursuit; and ensemble methods, such as boosting, bootstrapped aggregation (bagging), AdaBoost, stacked generalization, gradient boosting machines, and random forests.

Additionally, each processing portion of system 100 may utilize probabilistic modules, heuristic modules, deterministic modules, or any other computational modules that use a combination of machine learning and other suitable computation methods. Machine learning and computational methods module 190 may allow each sub-module, such as alert categorization module 130, analysis and reasoning system 150, and response recommendation system 160, to utilize the most appropriate computational model for their specific functions, providing flexibility and adaptability in handling diverse security alerts.

Further, any suitable model, whether machine learning-based or non-machine learning-based, may be employed within machine learning and computational methods module 190 to implement various functions in system 100. The incorporation of these models, algorithms, and weak supervision methods may enable system 100 to achieve high levels of accuracy, efficiency, and scalability in processing, categorizing, analyzing, and responding to security alerts, ultimately enhancing the reliability of system 100 in managing cybersecurity incidents.

### 2. Method for Automated Investigation and Response to Security Alerts

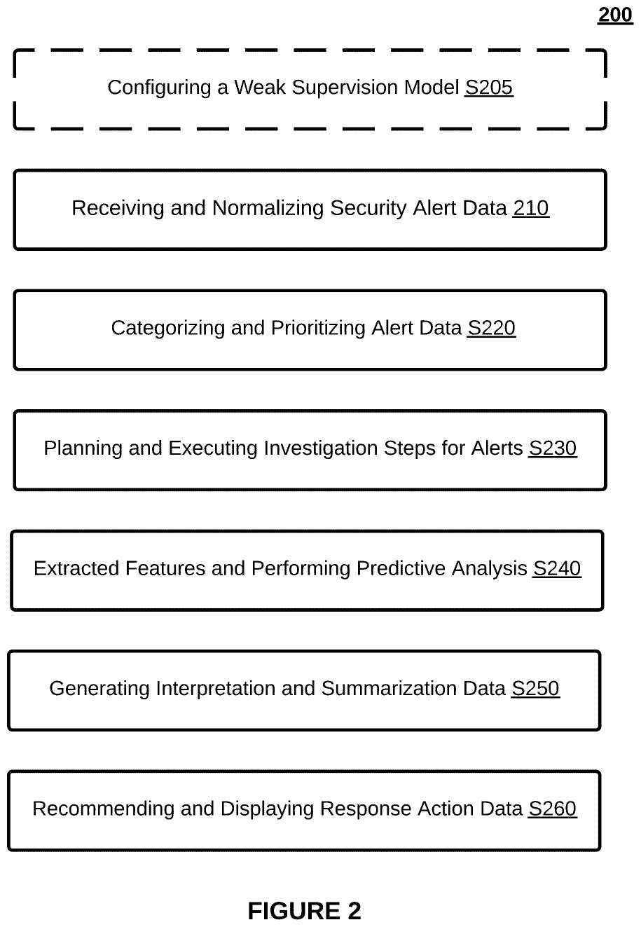

As shown in FIG. 2, method 200 for automated investigation and response to security alerts may include configuring one or more weak supervision models S205, receiving and normalizing security alert data S210, categorizing and prioritizing the alerts S220, planning and executing investigation steps for each alert S230, extracting features and performing predictive analysis S240, applying reasoning to the analysis results and summarizing the findings S250, and recommending and displaying response actions S260. Method 200 optionally includes configuring a weak supervision machine learning model S205.

### 2.05 Configuring Weak Supervision Models

S205, which includes applying weak supervision techniques, may enable machine learning models of system 100 to learn from incomplete, noisy, or limited labeled data, supporting predictive and reasoning capabilities across modules. Weak supervision methods, such as data programming, multi-instance learning, and generative modeling for label synthesis, may be applied in feature extraction, alert categorization, and predictive analysis. Synthesizing probabilistic labels and generating labeled training data from partially labeled sources may enhance system adaptability and performance, enabling each module to function effectively in data environments with variable data quality. Accordingly, weak supervision techniques may allow system 100 to generate reliable classifications and predictions even in scenarios where high-quality labeled data is sparse or unavailable, thereby increasing the robustness of system 100 in handling diverse and complex alert types.

In one or more embodiments, S205 may function to apply a combination of data programming, generative modeling, multi-instance learning, and other weak supervision strategies to synthesize probabilistic labels and improve model performance across various stages of the alert investigation and response workflow. Data programming, for instance, may involve the creation of labeling functions that apply heuristic rules to label large volumes of unlabeled data. These labeling functions may encode domain-specific knowledge, such as common indicators of phishing attempts or network intrusion patterns, allowing system 100 to label data points based on heuristic criteria rather than relying solely on human-labeled datasets.

Generative modeling for label synthesis may be implemented within S205 to combine multiple labeling sources into a single probabilistic label for each data point. In some embodiments, the generative model may learn to weigh the reliability of different labeling functions, accounting for potential inconsistencies or conflicts between sources. For example, if a heuristic function labels an alert as suspicious due to anomalous login behavior but another function does not, the generative model may assign a probabilistic label that reflects the uncertainty, enabling downstream modules to consider the relative confidence in each label when making predictions.

In some embodiments of the present application, configuring a weak supervision model may include establishing a set of labeling functions and corresponding feature relationships used to produce probabilistic outputs for investigative questions associated with a security alert. During configuration, the system may determine initial weight values for a plurality of SME-authored features that reflect the expected reliability, correlation, or analytical relevance of the underlying investigative signals. These weight values may be learned using unlabeled alert data, curated validation examples, or historical evidence patterns.

In additional embodiments of the present application, the configuration process may further establish that the weak supervision model is capable of performing incremental updates to its feature-weight parameters during inference, particularly in cases where new investigative questions are generated autonomously by an AI agent. To support such dynamic behavior, the configuration step may specify that the weight parameters corresponding to SME-authored features remain fixed once training is complete, thereby providing a stable baseline of expert-informed investigative logic. The system may also define a secondary set of weight parameters that may be learned or adapted in real time for features that did not exist during the original training cycle. These dynamically learned weights may correspond to Q&A features generated during investigation execution, including those produced by the AI agent based on newly collected evidence or alert-specific contextual signals.

In certain embodiments, the configuration process may further prepare the weak supervision model to evaluate newly added features in the absence of historical training data. This may include defining template relationships, initialization strategies, or bounds for dynamically generated weight parameters, enabling the model to accept new features without requiring full retraining. Through these enhancements, the configuration step may establish a hybrid weak-supervision framework in which SME-authored investigative logic forms a stable core, while AI-generated investigative logic may be incorporated dynamically as new features are introduced during alert processing.

In some embodiments of the present application, configuring a weak supervision model may further include establishing mechanisms for incorporating customer-generated investigative questions and answers into the model's analytical structure. During configuration, the system may define a mapping framework through which customer-designated importance levels such as Low, Medium, or High may be translated into numerical weight values that correspond to appropriate regions of the SME-derived weight distribution. This mapping may ensure that customer-generated features enter the analytical framework with weight values that are stable, interpretable, and consistent with the model's existing architecture. The configuration process may also specify that the weak supervision model is capable of operating in multiple predictive modes, including a baseline mode that evaluates SME-authored and AI-agent-generated features, and a customer-influenced mode that incorporates customer-generated features. These provisions may prepare the weak supervision model to perform parallel predictive and reasoning operations that reflect both the system's default interpretation and the customer-defined investigative priorities.

Additionally, or alternatively, S205 may employ multi-instance learning, where labels are assigned to sets or “bags” of instances rather than individual data points. In cases where it is impractical to label each instance directly, multi-instance learning may allow system 100 to infer patterns based on aggregate labels, increasing the efficiency of the learning process. For example, if a set of alerts from a particular source consistently shows signs of malicious activity, system 100 may use multi-instance learning to assign a higher likelihood of risk to future alerts from that source, even without direct labeling.

In one or more embodiments, S205 may integrate other weak supervision techniques, such as self-training and pseudo-labeling, to iteratively refine model accuracy. Self-training may involve using model predictions on unlabeled data as pseudo-labels, which are then incorporated into the training set to further train the model. The iterative process may enable predictive analysis module 154 to expand its labeled dataset autonomously, enhancing classification performance over time as system 100 learns from its predictions.

The output of S205 may be a set of probabilistic labels, synthesized features, or confidence-weighted training examples that are used to train or refine machine learning models within predictive analysis module 154, explanatory module 156, and other components of system 100. By applying weak supervision techniques, S205 may provide a flexible and adaptive approach to learning from noisy data, enhancing system 100's ability to detect, analyze, and respond to security threats in environments where labeled data is limited or inconsistent.

### 2.10 Receiving and Normalizing Security Alerts

S210, which includes receiving and normalizing security alerts for system 100, may function to acquire raw security alert data from a plurality of distinct sources, such as security information and event management (SIEM) systems, endpoint detection and response (EDR) solutions, extended detection and response (XDR) platforms, cloud detection and response (CDR), and other security monitoring tools. S210 may process incoming alerts to validate, standardize, and enrich the data to ensure compatibility and interoperability across downstream components of system 100.

In one or more embodiments, S210 may function to receive raw security alert data into alert ingestion module 110. Alert ingestion module 110 may connect to external security platforms via an application programming interface (API) that enables automated data intake across various alert formats and communication protocols. In some implementations, alert ingestion module 110 may filter incoming data, removing incomplete or redundant alerts to optimize system performance. It shall be noted that alert ingestion module 110 may also be referred to herein as an “alert ingestion engine” or the like.

In one or more embodiments, alert ingestion module 110 may validate each received alert based on predefined criteria, confirming that alert data is complete and relevant before proceeding to normalization. The validation may involve checking the integrity of fields, metadata accuracy, and adherence to expected data structures. Once validated, the data may be passed to alert normalization module 120 for standardization.

Alert normalization module 120 may function to transform the raw alert data into a standardized format compatible with system 100. The normalization process may involve applying data mapping rules or templates, which may translate source-specific fields, such as “src_ip” or “source_ip,” to a common field name, such as “source IP address.” In some embodiments, alert normalization module 120 may also perform data enrichment, adding contextual information to each alert, such as IP reputation scores, geographic location, or domain characteristics, to enhance downstream processing. Enriched data may provide a more comprehensive view of the alert context, allowing subsequent modules to make better-informed decisions.

Additionally, or alternatively, S210 may employ machine learning models within alert normalization module 120 to adaptively recognize and map fields from new or evolving data sources, facilitating the integration of alerts from diverse security systems without extensive manual configuration. The machine learning models may utilize algorithms such as decision trees, support vector machines, or ensemble methods to accurately map data from disparate sources into a consistent structure.

The output of S210 may be a standardized and enriched set of alert data, which may be routed to alert categorization module 130 for further processing. By receiving, validating, normalizing, and enriching security alert data, S210 may enhance the compatibility, efficiency, and accuracy of the alert investigation workflow within system 100, ultimately supporting a more seamless and effective security response.

### 2.20 Categorizing and Prioritizing Security Alerts

S220, which includes categorizing and prioritizing alerts within system 100, may function to assign each incoming security alert to a specific category and priority level based on predefined attributes. The categorization and prioritization process may guide downstream modules in system 100, ensuring that high-risk or high-priority alerts receive timely attention and tailored investigation paths.

In one or more embodiments, S220 may function to process the normalized and enriched security alert data provided by alert normalization module 120. In such embodiments, alert categorization module 130 may analyze each alert's characteristics, such as alert type, severity, detection source, and relevant metadata, to determine an appropriate category label. Categories may include, but are not limited to, anomalous logins, phishing attempts, malware detections, and network intrusions. By assigning category labels, alert categorization module 130 may enable system 100 to streamline the alert investigation process by grouping alerts with similar characteristics for specialized processing.

In one or more embodiments, alert categorization module 130 may employ rule-based logic, machine learning algorithms, or a combination thereof to categorize alerts. Rule-based logic may define specific conditions that assign alerts to categories based on known attributes or indicators. For example, an alert originating from a foreign IP address with multiple failed login attempts may be automatically categorized as a potential unauthorized access attempt. Alternatively, machine learning algorithms, such as decision trees, support vector machines, or neural networks, may be used to identify patterns in alert data and dynamically categorize alerts based on learned relationships between attributes. Machine learning-based categorization may enhance flexibility, enabling system 100 to adapt to new or evolving types of alerts without requiring extensive manual rule updates.

Additionally, or alternatively, alert categorization module 130 may incorporate weak supervision techniques to categorize alerts based on partially labeled data, adapting prioritization schemes to emerging alert types and trends. Weak supervision algorithms, such as generative modeling for label synthesis, may create probabilistic labels that guide categorization with limited labeled training data. The implementation of alert categorization module 130 in this way may function to support an ability of system 100 to prioritize high-risk alerts based on evolving threat characteristics, enhancing flexibility in response to changing security conditions.

Additionally, or alternatively, S220 may function to prioritize alerts within each category based on criteria such as severity level, source credibility, or frequency of occurrence. In some embodiments, prioritization component 134 within alert categorization module 130 may assign a prioritization score or level to each alert, indicating the urgency or importance of further investigation. For instance, alerts with a high severity level or originating from a system component may be assigned a higher priority, ensuring they are processed promptly within the investigation workflow. Prioritization component 134 may also apply historical data analysis to detect recurring alert patterns, allowing it to differentiate between common, lower-risk events and rare, high-risk occurrences that warrant faster responses.

In one or more embodiments, S220 may further refine prioritization using machine learning models capable of assessing risk based on alert context and historical performance. Such models may include logistic regression, random forests, or gradient boosting machines, which analyze features associated with previous high-risk alerts to dynamically prioritize incoming alerts. Weak supervision techniques may also be applied within alert categorization module 130, allowing the module to learn from limited labeled data, thereby improving prioritization accuracy over time.

The output of S220 may be a set of categorized and prioritized alerts, each labeled with a specific category and associated priority level, which may then be routed to automated alert investigation system 140. By categorizing and prioritizing alerts, S220 may streamline the investigation process, directing system resources toward high-risk alerts and enabling a more efficient and focused security response within system 100.

### 2.30 Planning and Automatically Executing Investigation Steps

S230, which includes planning and executing investigation steps, may function to create and adapt an investigation plan tailored to each alert through the combined roles of investigation planner module 142 and investigation decider module 143 within automated alert investigation system 140. Investigation planner module 142 may initially define the sequence of investigative steps based on a categorization and priority level of the alert, establishing a structured workflow for efficient data gathering and analysis. For example, an investigation plan may include steps such as evidence retrieval, IP reputation checks, and endpoint log analysis.

In some embodiments of the present application, planning and executing investigation steps may include generating, from an alert categorization result, a set of investigation steps appropriate for the alert's type and context. These steps may be organized within a directed acyclic graph that defines their execution order, data dependencies, and opportunities for parallelization. The system may execute a sequence of SME-authored enrichment and analysis steps, each of which may specify particular evidence to collect and particular investigative questions to apply to that evidence. Execution of these steps may yield SME-generated evidence and corresponding Q&A feature data that reflect an expert-informed understanding of how to evaluate the alert.

In additional embodiments of the present application, the execution phase may further include invoking an autonomous AI agent after the SME-authored steps have been run, enabling the system to expand the investigation beyond the predefined SME workflow. Upon receiving the SME-generated evidence and Q&A features, the AI agent may analyze the intermediate investigative state and determine that additional evidence or new investigative questions are required to fully characterize the alert. The planning logic may therefore include an adaptive portion in which the AI agent identifies new investigative actions that were not pre-specified by SMEs and may request that such actions be incorporated into the ongoing execution sequence.

The execution of these AI-agent-generated investigative actions may include autonomous retrieval of additional evidence using available model context protocol tools to query threat intelligence services, telemetry providers, log systems, or other external data sources not explicitly enumerated in the SME-authored plan. The system may incorporate such evidence into the investigation flow, treating it with the same procedural rigor and data-normalization requirements applied to SME-generated evidence. The AI agent may also generate its own investigative questions corresponding to the newly collected evidence, and the system may apply one or more large language models or automated analytical mechanisms to generate answers to those questions, thereby producing dynamically generated Q&A features.

In certain embodiments, the planning component of S230 may further recognize that AI-agent-generated investigative tasks may be executed in parallel with remaining SME-authored steps or may be sequenced as dependent steps requiring completion of certain evidence-collection operations. The execution component may therefore adjust the investigation flow in real time, incorporating dynamically generated steps into the overall DAG and ensuring that dependent steps are executed only once prerequisite evidence is available. This adaptive execution behavior may allow the investigation pipeline to evolve during runtime in response to alert-specific signals observed by the AI agent.

In one or more embodiments, S30 includes implementing investigation decider module 143 to assess findings after each investigation step, dynamically adjusting the investigation path or workflow as needed. For instance, if initial steps reveal a high-risk indicator, investigation decider module 143 may escalate the alert for immediate attention or initiate additional investigation actions. Alternatively, if the evidence suggests benign activity, investigation decider module 143 may terminate the investigation early to conserve resources. In such embodiments, an adaptive approach allows automated alert investigation system 140 to adjust investigative actions in real-time, ensuring that high-priority alerts receive focused attention while routine or low-risk alerts are handled efficiently.

S230, which includes planning and executing investigation steps for categorized alerts within system 100, may function to create a structured investigation workflow tailored to the specific category and priority of each alert. The planning and execution of investigation steps may enable system 100 to systematically gather and analyze relevant evidence, ensuring that each alert is comprehensively assessed based on its unique characteristics and risk level.

In one or more embodiments, S230 may function to initiate an investigation plan through investigation planner module 142 within automated alert investigation system 140. Investigation planner module 142 may generate a customized sequence of investigative actions for each alert category, which may be represented as a directed acyclic graph (DAG) or similar workflow structure. The investigation plan may specify a logical order of actions to be performed, such as data retrieval, pattern recognition, and anomaly detection, based on the alert's category and priority level. For example, an alert categorized as a potential phishing attempt may require steps focused on examining email headers, sender reputation, and embedded links, while a malware detection alert may prioritize steps involving file hash analysis, endpoint inspection, and external threat intelligence queries.

In one or more embodiments, investigation planner module 142 may employ rule-based decision logic or machine learning algorithms to define optimized investigation workflows for each alert type. Rule-based logic may outline specific investigative actions based on established protocols or threat detection criteria, while machine learning models may dynamically adjust investigation plans by analyzing historical data and identifying effective investigation strategies. Machine learning models may include algorithms such as decision trees, neural networks, or reinforcement learning, which may learn optimal investigation paths based on prior outcomes, enabling system 100 to refine workflows over time.

Once an investigation plan is established, S230 may function to execute the investigation steps in accordance with the plan through investigation executor module 144. Investigation executor module 144 may coordinate the execution of both synchronous and asynchronous tasks, managing the timing and dependencies between investigative actions. In some embodiments, investigation executor module 144 may perform tasks in parallel where possible to reduce investigation time, particularly for high-priority alerts. For instance, evidence collection, data processing, and external lookups may occur concurrently, allowing system 100 to accelerate the overall investigation process without sacrificing thoroughness.

Investigation executor module 144 may interact with evidence collection module 146 to retrieve relevant contextual data for each alert, drawing from external threat intelligence databases, internal security logs, and other informational sources. Evidence collection module 146 may acquire data such as IP reputation scores, domain characteristics, and network traffic patterns that may be relevant to the alert context. In one or more embodiments, evidence collection module 146 may employ API integrations with third-party data providers or utilize machine learning-based enrichment techniques to ensure that all pertinent information is gathered efficiently and accurately.

The output of S230 may be a set of investigation findings, including collected evidence, preliminary analyses, and any identified threat indicators, which may be passed to analysis and reasoning system 150 for further processing. By planning and executing a structured sequence of investigation steps, S230 may provide a systematic approach to evaluating each alert, enabling system 100 to generate well-supported insights and recommendations while reducing investigation time and resource consumption.

Through these enhancements, S230 may accommodate a hybrid investigation model in which the SME-authored plan defines an initial investigation structure, and an AI agent supplements that plan by generating additional investigative questions, collecting additional evidence, and triggering new investigative steps that extend the depth and specificity of the investigation. This dynamic expansion of the investigative sequence enables the system to adapt its analytic scope to the unique characteristics of each alert, thereby improving investigative completeness without requiring SMEs to enumerate all possible investigative paths in advance.

### 2.40 Extracting Features and Performing Predictive Analysis

S240, which includes extracting features and performing predictive analysis on investigation findings within system 100, may function to derive structured insights from collected evidence and assess the likelihood of each alert being benign or malicious. The feature extraction and predictive analysis process may enable system 100 to quantify alert characteristics and generate probabilistic classifications, supporting data-driven decision-making in subsequent steps.

In one or more embodiments, S240 may function to extract relevant features from the evidence collected by evidence collection module 146 within automated alert investigation system 140. Feature extraction may be conducted by feature extraction module 152, which may analyze raw data, metadata, and contextual details gathered during the investigation phase to identify specific attributes or indicators associated with each alert. Features may include IP address reputation, geographic location, file hash values, domain age, frequency of access, or behavioral anomalies. These extracted features may serve as structured inputs that summarize the salient characteristics of each alert, allowing for a standardized format across diverse alert types.

In one or more embodiments, feature extraction module 152 may utilize machine learning models or language models to process complex data and answer predefined security-related questions. For example, a language model may analyze email content for indications of phishing, while an anomaly detection model may flag deviations in user login behavior. Each answer generated through these models may be converted into a numerical or categorical feature, providing a comprehensive dataset that represents the alert's context and potential risk factors. Feature extraction module 152 may employ a combination of supervised and unsupervised learning techniques, such as support vector machines, clustering algorithms, or neural networks, to identify patterns within the evidence and extract high-impact features.

Additionally, or alternatively, in one or more embodiments, feature extraction module 152 may utilize language models to generate question-answer pairs based on collected evidence, wherein each Q&A pair addresses a specific security-related question about the alert context. For example, system 100 may generate answers to questions such as ‘Is the login attempt from a recognized IP address?’ or ‘Does the email domain have a history of phishing activity?’ These answers may be converted into structured features, representing the alert's characteristics and potential risk factors in a standardized format. The Q&A-based feature extraction technique enables system 100 to derive deeper contextual insights, enhancing the predictive accuracy and interpretability of the analysis process.

Following feature extraction, S240 may function to perform predictive analysis on the derived features using predictive analysis module 154. Predictive analysis module 154 may apply machine learning models to classify the alert as benign, malicious, actionable, or non-actionable, based on the extracted features. In one or more embodiments, predictive analysis module 154 may use algorithms such as logistic regression, random forests, gradient boosting, or neural networks, which may analyze relationships between features and classify alerts with associated confidence scores. The use of probabilistic models may allow predictive analysis module 154 to provide nuanced assessments, offering insights into the likelihood of an alert being associated with malicious activity.

In some embodiments of the present application, extracting features and performing predictive analysis may include transforming the evidence gathered during the investigation into a set of structured Q&A features suitable for consumption by downstream predictive and reasoning systems. The system may evaluate SME-authored investigative questions against the SME-collected evidence and may generate corresponding answers using automated analysis routines or large language models configured to operate over the available evidence. The resulting SME-authored Q&A features may be assembled into a feature vector that forms the analytical basis for predicting whether an investigative question should be answered affirmatively, negatively, or in a manner indicating insufficient information.

In additional embodiments of the present application, the feature extraction and predictive analysis stage may further include evaluating dynamically generated investigative questions produced by an autonomous AI agent during execution of the investigation. When such dynamically generated questions are present, the system may analyze the newly collected evidence associated with those questions and may generate corresponding answers using one or more language models configured to ground their responses in the evidence assembled by both SME-authored and AI-agent- generated enrichment routines. These dynamically generated answers may be packaged with their associated questions to form a new set of Q&A features that expand the analytical scope of the investigation beyond the SME-defined Feature Space.

The system may incorporate both SME-authored and AI-generated Q&A features into a consolidated feature representation, which may then be provided to a weak supervision model for probabilistic interpretation. In certain embodiments, this consolidated representation may include metadata indicating whether each feature originates from SME-authored investigative logic or was dynamically introduced by the AI agent, enabling the predictive analysis process to treat these categories of features differently. When dynamically generated features are encountered, the predictive analysis stage may activate an incremental weak-supervision learning procedure in which the weight parameters associated with SME-authored features remain fixed while the weight parameters associated with AI-generated features are learned or updated based on available evidence and correlation patterns observed during inference.

In further embodiments, the predictive analysis stage may compute probabilistic predictions for each investigative question represented by the combined feature set. Such predictions may reflect the system's assessment of whether the evidence supports a particular investigative conclusion and may incorporate contributions from both the static SME-defined feature relationships and the dynamic feature relationships learned through incremental updates. The predictive analysis process may also generate metadata describing the influence of individual features, including whether dynamically generated features strengthened, weakened, or otherwise altered the probabilistic outcome relative to the SME-authored features.

Through these enhancements, S240 may support a dynamic and adaptive feature extraction and prediction process in which the system's analytical inputs evolve in real time based on the behavior of an autonomous AI agent. This expanded feature-processing capability enables the predictive analysis stage to incorporate new investigative signals, adjust its internal weighting structures without full retraining, and generate richer probabilistic assessments that take into account newly discovered evidence and context-specific investigative logic.

In some embodiments of the present application, extracting features and performing predictive analysis may additionally include processing customer-generated investigative questions and answers. When such customer inputs are present, the system may convert them into structured Q&A feature representations consistent with the SME-authored and AI-generated features, while also retaining metadata describing their provenance and customer-specified importance. The system may translate the customer-defined importance values into numerical weight parameters by mapping them to ranges of SME-derived weights, thereby ensuring that the relative strength of customer-generated features aligns with the model's calibrated feature space.

In additional embodiments, the predictive analysis stage may generate two parallel sets of predictive outputs. A first predictive path may operate solely on SME-authored and AI-agent-generated Q&A features, thereby producing a baseline probabilistic assessment. A second predictive path may incorporate both the baseline features and the customer-generated Q&A features, producing a customer-influenced probabilistic assessment. The predictive analysis module may then record whether the inclusion of customer-generated features alters the inference results, modifies confidence levels, or changes the classification associated with any investigative step.

Through these enhancements, S240 may support a predictive framework that integrates customer-defined investigative logic in a structured and transparent manner, while preserving the default predictive behavior of the system.

In one implementation, as shown in FIG. 4, predictive analysis module 154 may employ weak supervision techniques to learn from partially labeled or noisy data, enhancing alert classification. Weak supervision methods, such as data programming or multi-instance learning, may generate probabilistic labels from limited data sources, expanding training data without extensive manual labeling. The process may improve predictive accuracy and classification reliability, particularly in environments with variable data quality.

In one or more embodiments, S240 may utilize weak supervision techniques within predictive analysis module 154 to handle scenarios where labeled data is limited or incomplete. Weak supervision may enable system 100 to learn from noisy, low-quality, or partially labeled datasets by synthesizing labels from multiple sources or heuristics. Algorithms such as data programming, multi-instance learning, or generative modeling may enhance the accuracy and robustness of the predictions, allowing system 100 to adapt to changing threat landscapes and maintain high classification performance over time.

The output of S240 may be a set of classified alerts, each associated with a confidence score and a set of supporting features. These classified alerts may then be passed to explanatory module 156 within analysis and reasoning system 150, where structured reasoning may be applied to explain and contextualize the classification. By extracting features and performing predictive analysis, S240 may provide a rigorous, data-driven assessment of each alert, enabling system 100 to prioritize resources and make informed security decisions.

### 2.50 Applying Reasoning and Summarizing Findings

S250, which includes applying reasoning to analysis results and summarizing findings within system 100, may function to provide structured explanations for alert classifications and generate clear, concise summaries of investigation outcomes. By applying reasoning and summarization, system 100 may enhance transparency in its decision-making process, allowing security analysts to understand the basis for each alert's classification and quickly review key insights.

In one or more embodiments, S250 may function to apply structured reasoning to the predictive analysis results generated by predictive analysis module 154. Explanatory module 156 within analysis and reasoning system 150 may evaluate the classification of each alert, incorporating both the extracted features and the confidence scores associated with predictive analysis outputs. Explanatory module 156 may use logic-based frameworks, rule-based decision trees, or machine learning algorithms to emulate human-like reasoning, providing a step-by-step explanation of why each alert was classified in a specific way. For example, if an alert was classified as a phishing attempt, explanatory module 156 may outline the relevant features—such as suspicious domain age, unrecognized sender, and use of phishing keywords—that contributed to the classification.

In some embodiments of the present application, generating reasoning and summarization data may include evaluating the probabilistic outputs produced during predictive analysis and determining, for each investigative step, whether the evidence supports an affirmative or negative answer to the overarching investigative question. The system may synthesize the outputs of the weak-supervision model, integrate the contributions of the various Q&A features, and derive a structured reasoning output that indicates whether the alert exhibits characteristics of malicious behavior, benign behavior, or ambiguous behavior requiring further review.

In some embodiments of the present application, generating reasoning and summarization data may additionally include evaluating reasoning outputs produced through both the baseline and customer-influenced predictive pathways. When customer-generated investigative questions or answers materially affect the predictive outputs associated with an investigative step, the reasoning stage may incorporate these differences into its synthesis of the final investigative conclusion. The reasoning module may determine whether customer-generated features contributed significantly to the outcome, such as by elevating or reducing the severity classification or altering the system's confidence in its assessment. The reasoning output may therefore include explanatory metadata that reflects the customer's impact on the analytical pathway.

The summarization portion of S250 may provide a narrative representation of how customer-generated features influenced the investigation. The system may describe whether customer importance levels amplified or attenuated the contribution of particular investigative signals, whether customer-generated questions resolved ambiguities left by SME or AI-agent features, or whether customer-specific reasoning paths introduced context that would otherwise have been unavailable to the system. Through such explanations, the summary may provide transparency regarding the customer's role in shaping the final investigative outcome.

Accordingly, in one or more embodiments, explanatory module 156 may utilize Q&A-based features generated by feature extraction module 152 to apply structured reasoning to each alert. The Q&A responses offer interpretable context that may clarify why specific characteristics of an alert led to a certain classification. As a non-limiting example, if a phishing alert is classified as high-risk, explanatory module 156 may highlight relevant Q&A responses, such as ‘Does the email contain common phishing phrases?’ and ‘Is the IP address flagged for malicious activity?’ The extracted features provide transparency into the reasoning process, enabling security analysts to understand the factors behind each classification.

Additionally, or alternatively, explanatory module 156 may use weak supervision techniques to improve interpretability and generate structured explanations based on probabilistic labels and synthesized features. Weak supervision enables explanatory module 156 to assess relationships between partially labeled features, allowing system 100 to apply logic-driven reasoning despite limited labeled training data. The interpretive reasoning capability of explanatory module 156 may ensure that classifications are accompanied by contextually relevant explanations, improving system transparency and aiding analyst decision-making.

In one or more embodiments, explanatory module 156 may be configured to identify and/or highlight the most influential features and evidence for each classification, offering security analysts insight into the factors that impacted the decision. Machine learning algorithms, such as SHAP (SHapley Additive exPlanations) or LIME (Local Interpretable Model-agnostic Explanations), may be used to determine feature importance and enhance interpretability. In such embodiments, the interpretive reasoning may help security analysts understand the classification of alert classification and the rationale behind the confidence level generated by system 100, allowing analysts to validate or challenge the conclusions if needed.

Following the reasoning process, S250 may function to generate a summary of the investigation findings through summarization module 162 within response recommendation system 160. Summarization module 162 may compile essential details of the investigation, including the alert category, key evidence, classification, and reasoning highlights, into a concise report format that is easy for security analysts to review. The summary may be generated using language models, natural language processing techniques, or rule-based templates that convert complex, technical information into plain language. The transformation may allow analysts to grasp the alert's significance quickly without having to review all underlying data manually.

In additional embodiments of the present application, the reasoning and summarization stage may further incorporate dynamically generated Q&A features produced by an autonomous AI agent during execution of the investigation. When such dynamic features are present, the reasoning process may evaluate their contributions alongside those of the SME-authored features, interpreting the dynamic features in the context of the existing investigative framework. The reasoning stage may therefore operate over an expanded feature space that includes both static SME-derived investigative signals and adaptive AI-agent-generated signals, synthesizing these heterogeneous inputs into a unified conclusion for the investigative step.

In certain embodiments, the reasoning component may further incorporate the weight parameters learned during incremental update procedures initiated in response to dynamically generated features. In these cases, the system may evaluate how the newly learned weight values influence the predictive outcomes and may determine whether the introduction of AI-generated investigative questions materially altered the reasoning path. The reasoning module may therefore generate metadata describing the interpretive role of dynamic features, including whether such features reinforced, contradicted, or introduced new analytical perspectives when compared to the SME-authored investigative logic.

In one or more embodiments, summarization module 162 may be tailored to highlight information based on alert severity, priority, or relevance. High-priority alerts may receive detailed explanations with specific recommendations, while low-priority alerts may be summarized more briefly. Summarization module 162 may also format the report in a way that enables quick scanning, using visual indicators, bullet points, or section headings to guide analysts through the content effectively.

The summarization stage of S250 may generate narrative or structured explanations describing how the system arrived at its conclusions. These explanations may reference the evidence collected, the Q&A features generated, and, when applicable, the influence of dynamically generated investigative features produced by the AI agent. The summarization component may explain whether the AI agent identified evidence sources that were not part of the original SME-authored workflow, whether answers to AI-generated questions played a significant role in shaping the reasoning outcome, or whether the SME-authored logic independently supported the conclusion. By incorporating these explanatory elements, the summarization process may enhance transparency and provide analysts with a human-readable description of how dynamic and static features jointly informed the investigative result.

The output of S250 may be a structured summary of findings, which includes the reasoning behind the alert classification, relevant supporting evidence, and key indicators. The summary may be routed to user interface module 170, where it may be displayed to security analysts for review and action. By applying structured reasoning and generating a clear summary of findings, S250 may enhance system 100's transparency and usability, providing security teams with actionable insights to make informed decisions efficiently.

Through these enhancements, S250 may provide a reasoning and summarization process that integrates both SME-informed analytical structures and adaptive, context-dependent insights generated by an autonomous AI agent. This hybrid reasoning approach enables the system to articulate conclusions that reflect both established investigative expertise and real-time analytical expansions, thereby improving the accuracy, richness, and explainability of automated alert investigations.

### 2.60 Recommending and Displaying Response Actions

S260, which includes recommending and displaying response actions within system 100, may function to generate actionable recommendations based on the findings of the investigation and present them to security analysts in an accessible and intuitive format. By recommending and displaying response actions, system 100 may provide security teams with clear guidance on how to address identified threats, supporting a timely and effective response to potential security incidents.

In one or more embodiments, S260 may function to generate response recommendations based on the conclusions drawn from explanatory module 156 and summarized by summarization module 162. Response recommendation module 164 within response recommendation system 160 may assess the alert's classification, severity, confidence score, and other relevant factors to suggest specific actions that are most appropriate for mitigating the identified risk. Suggested response actions may include, but are not limited to, isolating affected devices, blocking suspicious IP addresses, disabling compromised accounts, or escalating alerts to relevant security teams for further investigation. The response recommendations may be tailored to each alert's unique characteristics, ensuring that the proposed actions align with the level of risk and potential impact associated with the alert.

In some embodiments of the present application, recommending and displaying response action data may further include presenting visual indicators showing whether customer-generated Q&A features influenced the final recommended action or classification. The display may highlight differences between the baseline reasoning outcome and the customer-influenced outcome, enabling analysts to understand how customer-defined investigative logic shaped the system's conclusions. When customer-generated inputs alter the prioritization, severity, or recommended remediation path, the interface may reflect this influence in the summary and action panels presented to the user.

In one or more embodiments, response recommendation module 164 may use rule-based decision logic, machine learning models, or a combination of both to determine the optimal response for each alert. Rule-based logic may involve predefined conditions that map specific classifications or severities to recommended actions, while machine learning models may dynamically adjust recommendations based on historical response effectiveness and evolving threat patterns. For instance, if previous incidents have shown that certain types of phishing attacks are best mitigated by blocking specific domains, system 100 may prioritize the action for similar alerts in the future. Response recommendation module 164 may also incorporate feedback from security analysts, captured through feedback module 180, to continuously refine and improve the accuracy and relevance of its suggestions.

Additionally, or alternatively, S260 may format response recommendations in a way that enables quick and efficient review by security analysts. Once generated, response recommendations may be passed to user interface module 170, where they may be organized and displayed in a structured format that facilitates rapid decision-making. In some embodiments, user interface module 170 may employ visual indicators, such as icons, color-coded alerts, or priority flags, to highlight the most urgent or high-risk recommendations, directing analysts'attention to actions that may require Immediate Attention.

Accordingly, the output of S260 may be a set of response recommendations displayed to security analysts in an actionable format, along with any interactive tools or controls needed to implement the suggested actions. By providing well-informed, tailored recommendations and an intuitive interface for review and execution, S260 may facilitate rapid response to security threats within system 100, helping organizations to mitigate risks effectively and safeguard their digital assets.

### 3. Computer-Implemented Method and Computer Program Product

Embodiments of system 100 and/or method 200 can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of the embodiments defined in the following claims.

We claim:

1. A computer-implemented method for accelerated cybersecurity threat detection, the method comprising:
at a remote cybersecurity service implemented by a network of distributed computers:
generating, by one or more computers of the cybersecurity service, a cybersecurity alert classification of a plurality of cybersecurity alert classifications based on cybersecurity alert data associated with a subscriber to the cybersecurity service;
accessing, from a memory storing a plurality of cybersecurity investigation instructions, a classification-indexed investigation set of instructions based on the generated cybersecurity alert classification;
forming a corpus of evidence by accessing one or more sources of evidence based on executing the classification-indexed investigation set of instructions;
generating, for a plurality of investigative questions associated with the investigation set of instructions, a corresponding model-generated answer that forms a question-and-answer (Q&A) pair by applying an automated analysis model to the corpus of evidence;
implementing a feature-extraction that encodes each investigative question of the plurality of investigation questions and the corresponding model-generated answer into a machine-readable feature value, the feature-extraction being configured to transform evidence signals into feature vectors consumable by a weak-supervision predictive model;
extracting, from the plurality of Q&A pairs, a feature set comprising feature values representing the answers generated for the investigative questions;
applying, to the feature set, a weak-supervision predictive model stored in the memory and executable by the one or more processors, the weak-supervision predictive model being configured to compute, for each investigative question, a probabilistic output indicating whether the investigation evidence supports an affirmative or negative answer to that investigative question;
determining, based on the probabilistic outputs generated by the weak-supervision predictive model, an investigative conclusion for at least one of the investigation steps or for the cybersecurity alert data as a whole; and
producing, via a natural-language generation module executed by the one or more processors, a machine-generated summary comprising (i) a description of the investigation evidence accessed, (ii) the Q&A pairs generated, and (iii) the investigative conclusion, together with one or more system-generated recommended response actions associated with the cybersecurity alert data.

2. The method of claim 1, wherein accessing the classification-indexed investigation set of instructions comprises retrieving, from a classification-to-investigation index stored in the memory, a machine-readable investigation-step specification associated with the cybersecurity alert classification, the investigation-step specification defining a sequence of evidence-access operations and corresponding investigative questions.

3. The method of claim 1, wherein generating the corresponding model-generated answer for each investigative question comprises executing a question-conditioned inference model that receives, as input, (i) a representation of the investigative question and (ii) a bounded subset of the corpus of evidence, and outputs an answer token or answer confidence value forming the Q&A pair.

4. The method of claim 1, wherein applying the weak-supervision predictive model comprises combining the feature values of the feature set using a plurality of labeling functions or heuristics encoded in the weak-supervision predictive model, each labeling function being configured to evaluate correlations among the feature values to generate the probabilistic outputs for the investigative questions.

5. The method of claim 1, further comprising invoking, after generating the cybersecurity alert classification, an autonomous artificial-intelligence agent configured to evaluate the corpus of evidence and intermediate Q&A pairs and to determine whether additional evidence is required to complete the investigation.

6. The method of claim 5, further comprising, in response to the autonomous artificial-intelligence agent determining that additional evidence is required, expanding the corpus of evidence by the agent autonomously accessing one or more supplemental evidence sources via a plurality of threat-intelligence or telemetry-access tools exposed through an application programming interface.

7. The method of claim 5, wherein the autonomous artificial-intelligence agent generates one or more additional investigative questions not included in the classification-indexed investigation set of instructions, and wherein generating the corresponding model-generated answers further comprises applying the automated analysis model to the corpus of evidence to produce question-and-answer (Q&A) pairs corresponding to the additional investigative questions.

8. The method of claim 1, wherein applying the weak-supervision predictive model further comprises performing an incremental weight-learning process in which weight parameters associated with feature values derived from the classification-indexed investigation set of instructions remain fixed, while weight parameters associated with feature values corresponding to the additional investigative questions generated by the autonomous artificial-intelligence agent are learned or updated during inference.

9. The method of claim 8, wherein performing the incremental weight-learning process comprises executing, during inference, a real-time fine-tuning cycle in which the weak-supervision predictive model updates weight values associated with feature values corresponding to dynamically generated investigative questions, thereby generating updated probabilistic outputs for one or more investigative questions.

10. The method of claim 8, wherein the incremental weight-learning process further comprises generating a refined inference result by re-evaluating the feature set using the updated weight values, the refined inference result being more accurate than the initial inference result produced prior to the incremental weight-learning process.

11. The method of claim 9, further comprising repeating the real-time fine-tuning cycle until a convergence criterion is satisfied, the convergence criterion comprising a change threshold between successive probabilistic outputs or a stability threshold for a loss function associated with the weak-supervision predictive model.

12. The method of claim 1, further comprising receiving, from the subscriber, one or more subscriber-generated investigative questions and corresponding subscriber-generated answers, and incorporating the subscriber-generated investigative questions and answers into the plurality of Q&A pairs used to form the feature set.

13. The method of claim 12, further comprising applying, to each subscriber-generated investigative question, a subscriber-specified importance value selected from a set of predefined levels, and mapping the subscriber-specified importance value to a numerical weight by selecting a value from a corresponding region of a weight distribution associated with feature values of the weak-supervision predictive model.

14. The method of claim 1, further comprising generating, in parallel with the weak-supervision predictive model applied to the feature set, a baseline probabilistic output that excludes subscriber-generated Q&A pairs, and determining whether the inclusion of the subscriber-generated Q&A pairs changes at least one probabilistic output or the investigative conclusion.

15. The method of claim 14, further comprising producing, via the natural-language generation module, an influence-report segment that identifies differences between the baseline probabilistic output and the probabilistic output generated using the subscriber-generated Q&A pairs, the influence-report segment indicating whether subscriber-generated content altered a severity determination, confidence score, or recommended response action.

16. The method of claim 1, wherein generating the question-and-answer (Q&A) pairs further comprises executing a question-evaluation pipeline, the question-evaluation pipeline including: evidence-selection logic configured to retrieve, from one or more evidence sources, investigation evidence associated with a designated investigation step; a model-execution stage that applies an analytical model to the retrieved investigation evidence using the investigative question as a conditioning parameter to generate a model-generated answer; and a feature-encoding stage that converts the investigative question and the model-generated answer into a structured Q&A feature suitable for downstream probabilistic reasoning by the weak-supervision predictive model.

17. The method of claim 1, wherein generating the model-generated answers further comprises executing, by the one or more processors, a non-transitory computer-implemented question-analysis engine configured to automatically transform heterogeneous cybersecurity evidence inputs into structured feature values by applying a machine-learning model conditioned on predetermined investigative questions, thereby generating Q&A feature data that is not derivable through mere inspection of the investigation evidence.

18. A computer-implemented cybersecurity investigation system comprising:
one or more processors configured to execute instructions stored in a memory;
a memory storing:
(i) a plurality of cybersecurity investigation instructions including a set of classification-indexed investigation-step specifications, each investigation-step specification defining evidence-access operations and corresponding investigative questions;
(ii) an automated analysis model configured to generate model-generated answers from cybersecurity evidence;
(iii) a weak-supervision predictive model configured to generate probabilistic outputs for investigative questions; and
(iv) a natural-language generation module configured to produce machine-generated summaries;
a classification module executable by the one or more processors and configured to generate, based on cybersecurity alert data received from a subscriber computing environment, a cybersecurity alert classification corresponding to one of a plurality of predetermined cybersecurity alert classifications;
an investigation-plan retrieval module executable by the one or more processors and configured to access, from the memory, a classification-indexed investigation-step specification corresponding to the generated cybersecurity alert classification;
an evidence-access module executable by the one or more processors and configured to access one or more evidence sources to obtain a corpus of evidence based on the investigation-step specification;
a question-analysis engine executable by the one or more processors and configured to apply the automated analysis model to the corpus of evidence to generate, for each investigative question of the investigation-step specification, a corresponding question-and-answer (Q&A) pair;
a feature-extraction module configured to encode each investigative question and its corresponding model-generated answer into a machine-readable feature value and to form a feature set comprising feature values extracted from the plurality of Q&A pairs;
a predictive reasoning module executable by the processors to apply the weak-supervision predictive model to the feature set to compute, for each investigative question, a probabilistic output indicating whether the corpus of evidence supports an affirmative or negative answer to the investigative question;
an investigative-conclusion module executable by the processors to determine, based on the probabilistic outputs, an investigative conclusion for at least one investigation step or for the cybersecurity alert data as a whole; and
a summary-generation module executable by the processors to produce a machine-generated summary comprising a description of the evidence accessed, the Q&A pairs generated, the investigative conclusion, and one or more system-generated recommended response actions associated with the cybersecurity alert.

19. A computer-implemented method for generating machine-derived cybersecurity threat determinations, the method comprising:
executing, by one or more processors of a distributed cybersecurity service, a classification model over cybersecurity alert data received from a subscriber computing environment to produce classification output data identifying a cybersecurity alert classification;
retrieving, from a non-transitory computer memory storing a plurality of classification-indexed investigation-step specifications, an investigation-step specification associated with the cybersecurity alert classification, the investigation-step specification comprising machine-readable step descriptors that define (i) evidence-source identifiers and (ii) investigative-question identifiers;
accessing, by the one or more processors, a set of evidence signals from a plurality of cybersecurity evidence sources in accordance with the evidence-source identifiers and forming a machine-readable evidence corpus;
for each investigative-question identifier of the investigation-step specification, executing a question-conditioned inference model configured to:
(i) receive, as input, a vectorized representation of the investigative question and a vectorized representation of at least a portion of the evidence corpus;
implementing a feature-extraction operation that transforms each Q&A data element into a machine-readable feature value by encoding the investigative-question identifier and the model-generated answer value using a feature-encoding function, the feature-extraction operation generating a feature vector comprising a plurality of encoded feature values;
applying, by the one or more processors, a weak-supervision predictive model stored in the memory to the feature vector, the weak-supervision predictive model being configured to compute, for each encoded feature value, a probabilistic output value derived from a plurality of labeling functions that evaluate correlations among the encoded feature values;
determining, based on the probabilistic output values, a machine-generated investigative conclusion representing whether the cybersecurity alert corresponds to behavior that is benign, malicious, or indeterminate; and
producing, by a natural-language generation module executed by the one or more processors, a structured machine-generated summary comprising (i) a description of the evidence corpus, (ii) the Q&A data elements generated by the question-conditioned inference model, and (iii) the investigative conclusion, together with one or more automatically generated recommended cybersecurity response actions.

20. The method of claim 19, wherein executing the question-conditioned inference model comprises generating, from the evidence corpus, a structured question-and-answer data element that represents a machine-derived transformation of heterogeneous cybersecurity evidence into a feature value not derivable through manual inspection of the evidence, the transformation being performed by conditioning the inference model on the investigative-question identifier to produce an answer value that incorporates correlations among multiple evidence signals.
